(19) United States
(12) Patent Application Publication
(10) Pub. No.: US 2022/0412553 A1
(43) Pub. Date: Dec. 29, 2022

(54) SYSTEM AND METHOD FOR PERFORMING A PRESCRIBED BURN OF LAND CONTAINING VEGETATIVE GROUND FUEL

(71) Applicant: Waleed Sami Haddad, San Francisco, CA (US)

(72) Inventor: Waleed Sami Haddad, San Francisco, CA (US)

(21) Appl. No.: 17/845,404

(22) Filed: Jun. 21, 2022

Related U.S. Application Data
(60) Provisional application No. 63/216,088, filed on Jun. 29, 2021.

(51) Int. Cl. F23G 5/40; F23J 15/04; F23D 14/22; A62C 3/02; A01D 43/00

(52) U.S. Cl. CPC F23G 5/40; F23J 15/04; F23D 14/22; A62C 3/0257; A62C 3/0292; A01D 43/003; F23G 2209/261

(57) ABSTRACT

An apparatus configured to perform a prescribed burn of vegetative ground fuel comprises a movable platform configured to traverse ground that contains the vegetative ground fuel, and a burn chamber disposed on the movable platform. An ignition source is disposed in the burn chamber and configured to ignite vegetative ground fuel within a prescribed burn region of the ground. A containment arrangement is situated relative to the burn chamber and configured to confine burning of the vegetative ground fuel to the prescribed burn region. A discharge apparatus is positioned relative to the burn chamber and configured to expel residual effluent from the burn chamber. An extinguisher system can be included to extinguish residual flames and embers. A smoke filtration system can be included to filter residual effluent expelled from the burn chamber.

### RELATED PATENT DOCUMENTS

This application claims the benefit of Provisional Patent Application Ser. No. 63/216,088, filed on Jun. 29, 2021, to which priority is claimed pursuant to 35 U.S.C. § 119(e) and which is hereby incorporated herein by reference.

### BACKGROUND

Worldwide, wildfires are becoming more destructive and costly, with cascading impacts on forest health, community well-being and public infrastructure. Increasingly destructive wildfire behavior has been attributed to excessive fuel loads in forests and the Wildland-Urban Interface—an outcome of a century-old fire suppression strategy coupled with a warming climate.

### SUMMARY

One or more embodiments are directed to an apparatus configured to perform a prescribed burn of vegetative ground fuel. The apparatus comprises a movable platform configured to traverse ground that contains the vegetative ground fuel, and a burn chamber disposed on the movable platform. An ignition source is disposed in the burn chamber and configured to ignite vegetative ground fuel within a prescribed burn region of the ground. A containment arrangement is situated relative to the burn chamber and configured to confine burning of the vegetative ground fuel to the prescribed burn region. A discharge apparatus is positioned relative to the burn chamber and configured to expel residual effluent from the burn chamber. An extinguisher system can be included to extinguish residual flames and embers.

One or more embodiments are directed to an apparatus configured to perform a prescribed burn of vegetative ground fuel. A movable platform is configured to traverse ground that contains the vegetative ground fuel. A hitch is configured to couple the movable platform to a tow vehicle or a secondary movable platform. A burn chamber is disposed on the movable platform. A plurality of torches are disposed in the burn chamber and configured to ignite vegetative ground fuel within a prescribed burn region of the ground. An air supply system and a fuel supply system are fluidically coupled to the plurality of torches. A containment arrangement is situated relative to the burn chamber and configured to confine burning of the vegetative ground fuel to the prescribed burn region. A discharge apparatus is positioned relative to the burn chamber and configured to expel residual effluent from the burn chamber. An extinguisher system can be included to extinguish residual flames and embers. A smoke filtration system is configured to filter the residual effluent.

One or more embodiments are directed to a method of performing a prescribed burn of vegetative ground fuel. The method comprises moving a burn chamber over ground that contains the vegetative ground fuel, and igniting vegetative ground fuel within a prescribed burn region of the ground using torches disposed in the burn chamber. The method also comprises confining burning of the vegetative ground fuel to the prescribed burn region, and expelling residual effluent from the burn chamber. The method can also comprise filtering the expelled residual effluent received from the burn chamber. The method can further comprise extinguishing residual flames and embers.

The above summary is not intended to describe each disclosed embodiment or every implementation of the present disclosure. The figures and the detailed description below more particularly exemplify illustrative embodiments.

### BRIEF DESCRIPTION OF THE DRAWINGS

Throughout the specification reference is made to the appended drawings wherein:

FIG. 1 illustrates an apparatus configured to perform a prescribed burn of vegetative ground fuel in accordance with any of the embodiments disclosed herein;

FIG. 1A illustrates an implementation of an ignition source in the form of a torch in accordance with any of the embodiments disclosed herein;

FIG. 1B illustrates an implementation of an ignition source in the form of a torch in accordance with any of the embodiments disclosed herein;

FIG. 1C illustrates an insulating support for an igniter wire of a torch in accordance with any of the embodiments disclosed herein;

FIG. 1D illustrates a torch head in accordance with any of the embodiments disclosed herein;

FIG. 2 shows an embodiment of a prescribed burn (PB) vehicle in accordance with any of the embodiments disclosed herein;

FIG. 3 illustrates a PB vehicle which includes a movable platform that supports various components configured to perform a prescribed burn of vegetative ground fuel in accordance with any of the embodiments disclosed herein;

FIG. 4 illustrates an embodiment of a PB vehicle in accordance with any of the embodiments disclosed herein;

FIG. 5A is a schematic of various components of a PB vehicle in accordance with any of the embodiments disclosed herein;

FIG. 5B is a block diagram of various components of a PB vehicle in accordance with any of the embodiments disclosed herein;

FIG. 6 illustrates a PB vehicle in accordance with any of the embodiments disclosed herein;

FIG. 6A illustrates an embodiment of a burn chamber in accordance with any of the embodiments disclosed herein;

FIG. 6B illustrates a torch adjustment mechanism in accordance with any of the embodiments disclosed herein;

FIG. 7 illustrates a filtration apparatus of a PB vehicle in accordance with any of the embodiments disclosed herein;

FIG. 8 illustrates a PB vehicle in accordance with any of the embodiments disclosed herein;

FIG. 9 illustrates a PB vehicle in accordance with any of the embodiments disclosed herein; and

FIG. 10 illustrates a method of performing a prescribed burn of vegetative ground fuel in accordance with any of the embodiments disclosed herein.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

Embodiments of the disclosure are directed to systems and methods that provide for prescribed burns of land containing various forms of vegetative ground fuels. Particular embodiments are directed to systems and methods that provide for prescribed burns of forested and agricultural land. Embodiments of the disclosure provide superior prevention against wildfires, and make prescribed burns accessible to individual landowners and government agencies. Embodiments of the disclosure provide for prescribed burns that are safer, cleaner and cheaper that known approaches, and are scalable to meet the critical and increasing global need.

There is growing recognition that prescribed burns are an effective ground fuel management strategy and an emerging policy emphasis on using more ‘good fire’ on public lands by bolstering and developing the capacities of a prescribed burning workforce. This policy commitment has yielded long overdue recognition of the need to forge partnerships with tribal leaders to enhance knowledge and capacities for prescribed burning.

While there is emerging consensus around the need for greater capacity and a larger, well-trained workforce for prescribed burns, it remains unclear how swiftly policy changes can scale to meet the need to treat over 200 million acres of high fire risk forests from today's current capacity of 3 million acres. There are also tactical issues with making prescribed burns safer, cleaner and cheaper. Even with a larger and more skilled prescribed burn workforce, prescribed burns still run the risk of escaped fires, smoke hazard, and resulting carbon emissions, while placing the burden of hiring burn crews on private landowners, many of whom are low-income, elderly or disabled. Prescribed burns are also dependent on short and fast-changing burn windows and have restrictions based on terrain, ecology, and landscape conditions.

Prescribed burns today require extensive pre-planning, including identifying sites, creating fire breaks, and then igniting large areas by hand using drip torches, monitoring the burn as it spreads on its own with little to keep the spread in check, and finally ensuring that all fire and embers are extinguished. Under the current approach, prescribed burns will remain out of reach to many private land and forest owners/managers.

Given modern circumstances in which many homes, businesses, roadways, utilities and other critical, and often sensitive, resources are located in or near areas that have a high risk of fire, it is also important to be able to conduct prescribed burns adjacent to these populated and sensitive areas while minimizing the impact on the people, wildlife, and structures. In addition, the smoke and greenhouse gasses produced by fire is a significant contributor to climate change, so minimizing these effluents in the process of prescribed burning is highly desirable. All of this is difficult or impossible to do with the current methods of conducting prescribed burns.

Embodiments of the disclosure are directed to an automated platform that features an integrated set of tools to conduct highly controlled, all-weather prescribed burns on a variety of terrain. For convenience, this automated platform is referred to herein as a Prescribed Burn vehicle (also referred to herein as a BurnBot™). Similar to a Zamboni® machine or a lawn tractor, the PB vehicle processes only the enclosed, limited region directly below it, allowing the PB vehicle to safely and precisely burn areas at the tree lines, directly adjacent to homes, structures, or other high value assets.

Additional applications of a PB vehicle include backburning operations for wildfire suppression, “blacklining” to create a pre-burned fire break around a much larger area that will later be burned using conventional prescribed burn methods (such as using drip torches or drones dropping incendiary devices (e.g., fire balls)) as a way of burning very large areas faster, but much more safely and clean stubble burning of spent or unwanted crops which can help rejuvenate the soil in farmland and agroforestry. For example, the PB vehicle can perform a blacklining operation to create a pre-burned fire break around a parcel of land. The PB vehicle can create additional fire break stripes within the fire break perimeter (e.g., in a checkerboard pattern) to isolate the vegetative ground fuel in smaller regions within the fire break perimeter. The vegetative ground fuel in the smaller regions can be burned using drip torches or drones dropping incendiary devices.

In some implementations, ignition of the unwanted ground fuels is conducted using an ignition source, such as an array of high-temperature torches. Flames and embers are fully contained within a “fire box” region (referred to herein as a “burn chamber”) created by the PB vehicle to eliminate the risk of escape fire. The high burn temperature creates less smoke than existing methods such as drip torches, which use noxious accelerants such as diesel fuel or gasoline. The PB vehicle can also include a smoke capture and filtration system to mitigate the release of smoke into the atmosphere. The high-temperature torches with long flames also burn the smoke particles produced inside the burn chamber which further reduces the smoke even before the filtration step. As the PB vehicle passes over an area it has burned, the PB vehicle can be configured to extinguish any remaining flame or embers behind itself, further ensuring safety.

The PB vehicle can be implemented as an ATV (All Terrain Vehicle) style vehicle, and can be further ruggedized to access steep grades and rough terrain. A PB vehicle can be implemented as a self-propelled apparatus or an apparatus (e.g., a PB platform) which can be hitched to a tow vehicle (e.g., an ATV, truck, tractor, bulldozer). In some implementations, the PB vehicle can be configured as an autonomous vehicle requiring no driver or tow vehicle. The PB vehicle or PB platform can be configured to carry various tools, such as brush cutters to allow the PB vehicle to penetrate thick vegetation, a mulcher and/or a crusher/tamper/compressive roller to break down and compress any partially burned material to reduce oxygenation and, therefore, future risk of ignition.

The PB vehicle or platform can perform prescribed burns in dry conditions and also operate at night and at times, and in weather conditions, that would otherwise be off limits with current methods. The PB vehicle or platform brings automation to today's labor-intensive prescribed burning, making them safer, cleaner, cheaper and scalable to meet the urgent need for large-scale fuel management and prevent mega wildfires.

Embodiments of the disclosure are defined in the claims. However, below there is provided a non-exhaustive listing of non-limiting examples. Any one or more of the features of these examples may be combined with any one or more features of another example, embodiment, or aspect described herein.

Example Ex1. An apparatus configured to perform a prescribed burn of vegetative ground fuel, comprises a movable platform configured to traverse ground that contains the vegetative ground fuel, a burn chamber disposed on the movable platform, an ignition source disposed in the burn chamber and configured to ignite vegetative ground fuel within a prescribed burn region of the ground, a containment arrangement situated relative to the burn chamber and configured to confine burning of the vegetative ground fuel to the prescribed burn region, and a discharge apparatus positioned relative to the burn chamber and configured to expel residual effluent from the burn chamber.

Example Ex2. The apparatus according to Ex1, wherein the ignition source comprises a plurality of torches disposed in the burn chamber and configured to ignite vegetative ground fuel within a prescribed burn region of the ground.

Example Ex3. The apparatus according to Ex2, wherein the plurality of torches are directed towards the ground.

Example Ex4. The apparatus according to Ex2, wherein the plurality of torches comprises a first set of torches and a set of second torches, the first set of torches are directed towards the ground, and the second set of the torches are directed away from the ground and configured to burn smoke captured within the burn chamber.

Example Ex5. The apparatus according to one or more of Ex2 to Ex4, wherein each of the torches produces a flame having a length of about 1 foot to about 3 feet.

Example Ex6. The apparatus according to one or more of Ex1 to Ex5, wherein each of the torches produces a flame having a temperature of about 500° F. to about 3000° F.

Example Ex7. The apparatus according to one or more of Ex2 to Ex6, wherein each of the torches is operatively coupled to an igniter, and the igniter comprises at least one of an electrical discharge igniter, an RF heater, a microwave heater, a laser, and a chemical igniter.

Example Ex8. The apparatus according to one or more of Ex2 to Ex6, wherein each of the torches is operatively coupled to an igniter, each igniter comprises a high voltage source coupled to an electrical conductor extending axially along a respective torch, the electrical conductor comprises or is coupled to a hook at a terminal end of the electrical conductor, and the high voltage source is configured to generate an electrical arc at the hook for igniting a fuel transported through a respective torch.

Example Ex9. The apparatus according to one or more of Ex2 to Ex8, wherein each of the torches is operatively coupled to an igniter and comprises a plurality of chambers extending axially along an interior of each torch, a first chamber is configured to transport a fuel, a second chamber is configured to transport air, and a third chamber is configured to house an electrical conductor coupled to a high voltage source of the igniter.

Example Ex10. The apparatus according to one or more of Ex2 to Ex9, comprising a blower fluidically coupled to each of the torches and configured to supply air for supporting a flame generated by each torch.

Example Ex11. The apparatus according to one or more of Ex2 to Ex10, wherein the torches are configured to produce a flame using propane fuel received from a fuel supply system of the apparatus.

Example Ex12. The apparatus according to one or more of Ex1 to Ex11, wherein the containment arrangement comprises a front panel extending from the burn chamber and comprising a front hinged section configured to facilitate entry of vegetative ground fuel into the burn chamber, a rear panel extending from the burn chamber and comprising a rear hinged section configured to facilitate exit of burnt vegetative ground fuel out of the burn chamber, and opposing side panels extending from the burn chamber and comprising a lower non-flammable skirt configured to allow air to enter the burn chamber and inhibit embers, flames, and debris from exiting the burn chamber.

Example Ex13. The apparatus according to one or more of Ex1 to Ex12, wherein the discharge apparatus comprises a fan or a venturi disposed on a top surface of the burn chamber, the fan or venturi configured to expel the residual effluent from the burn chamber.

Example Ex14. The apparatus according to Ex13, wherein the discharge apparatus comprises a filtration system disposed at an exit of the fan or venturi.

Example Ex15. The apparatus according to Ex1 to Ex14, wherein the containment arrangement comprises perforated heat shields arranged to block a direct path of flames and debris to the discharge apparatus.

Example Ex16. The apparatus according to one or more of Ex1 to Ex15, comprising an extinguisher disposed within or proximate an exit of the burn chamber.

Example Ex17. The apparatus according to one or more of Ex1 to Ex16, comprising one or both of a roller and a mulcher disposed proximate an exit of the burn chamber.

Example Ex18. The apparatus according to one or more of Ex1 to Ex17, comprising a mulcher or a cutter disposed proximate an entry of the burn chamber.

Example Ex19. The apparatus according to one or more of Ex1 to Ex18, comprising a plurality of sensors.

Example Ex20. The apparatus according to Ex19, wherein the plurality of sensors comprises two or more of a temperature sensor, a smoke sensor, a gas analyzer, a fuel moisture sensor, a fuel flow sensor, a fuel pressure sensor, a GPS sensor, a camera, an anemometer, a color imaging sensor, a LIDAR sensor, a hyperspectral imaging sensor, a sensor for determining vegetation type, a sensor for determining vegetation density before burning, and a sensor for determining residual vegetation density after burning.

Example Ex21. The apparatus according to one or more of Ex1 to Ex20, comprising a computer-based control system configured to control autonomous or semi-autonomous operation of the apparatus.

Example Ex22. The apparatus according to one or more of Ex1 to Ex21, wherein the moveable platform comprises a platform of an autonomous vehicle or a driver-controlled vehicle.

Example Ex23. The apparatus according to one or more of Ex1 to Ex22, wherein the movable platform comprises a hitch configured to couple to a tow vehicle.

Example Ex24. The apparatus according to one or more of Ex2 to Ex23, wherein the movable platform comprises a first platform situated ahead of a second platform relative to the direction of travel, the second platform is configured to support the burn chamber, the torches, the containment arrangement, and the discharge apparatus, and the first platform is configured to support a generator for the apparatus, a fuel supply configured to supply fuel to the torches, a blower configured to supply air to the torches, and a computer-based control system configured to control operation of the apparatus.

Example Ex25. The apparatus according to Ex1, wherein the ignition source comprises a heating filament.

Example Ex26. The apparatus according to Ex1, wherein the ignition source comprises a pilot flame and a fuel supply apparatus configured to deliver fuel to be ignited by the pilot flame.

Example Ex27. The apparatus according to one or more of Ex1 to Ex26, comprising a smoke filtration system configured to filter the residual effluent.

Example Ex28. The apparatus according to Ex27, wherein the smoke filtration system comprises a tank containing a filtering liquid, a sprinkler system disposed within ductwork of the smoke filtration system, a pump disposed in the tank and configured to pump the filtering liquid through the sprinkler system, and an outlet for expelling filtered air.

Example Ex29. A method of performing a prescribed burn of vegetative ground fuel comprises moving a burn chamber of a prescribed burn (PB) vehicle over ground that contains the vegetative ground fuel, igniting vegetative ground fuel within a prescribed burn region of the ground using torches disposed in the burn chamber, confining burning of the vegetative ground fuel to the prescribed burn region, and expelling residual effluent from the burn chamber.

Example Ex30. The method according to Ex29, wherein the prescribed burn of the vegetative ground fuel is performed continuously while moving the burn chamber over the ground.

Example Ex31. The method according to Ex29, wherein the prescribed burn of the vegetative ground fuel is performed by temporarily halting movement of the burn chamber at the prescribed burn region.

Example Ex32. The method according to one or more of Ex29 to Ex31, processing smoke and gasses expelled from the burn chamber with a smoke filtration system of the PB vehicle.

Example Ex33. An apparatus configured to perform a prescribed burn of vegetative ground fuel comprises a movable platform configured to traverse ground that contains the vegetative ground fuel, a hitch configured to couple the movable platform to a tow vehicle or a secondary movable platform, a burn chamber disposed on the movable platform, a plurality of torches disposed in the burn chamber and configured to ignite vegetative ground fuel within a prescribed burn region of the ground, an air supply system and a fuel supply system fluidically coupled to the plurality of torches, a containment arrangement situated relative to the burn chamber and configured to confine burning of the vegetative ground fuel to the prescribed burn region, a discharge apparatus positioned relative to the burn chamber and configured to expel residual effluent from the burn chamber, and a smoke filtration system configured to filter the residual effluent.

Example Ex34. The apparatus according to Ex33, wherein the smoke filtration system comprises a tank containing a filtering liquid, a sprinkler system disposed within ductwork of the smoke filtration system, a pump disposed in the tank and configured to pump the filtering liquid through the sprinkler system, and an outlet for expelling filtered air.

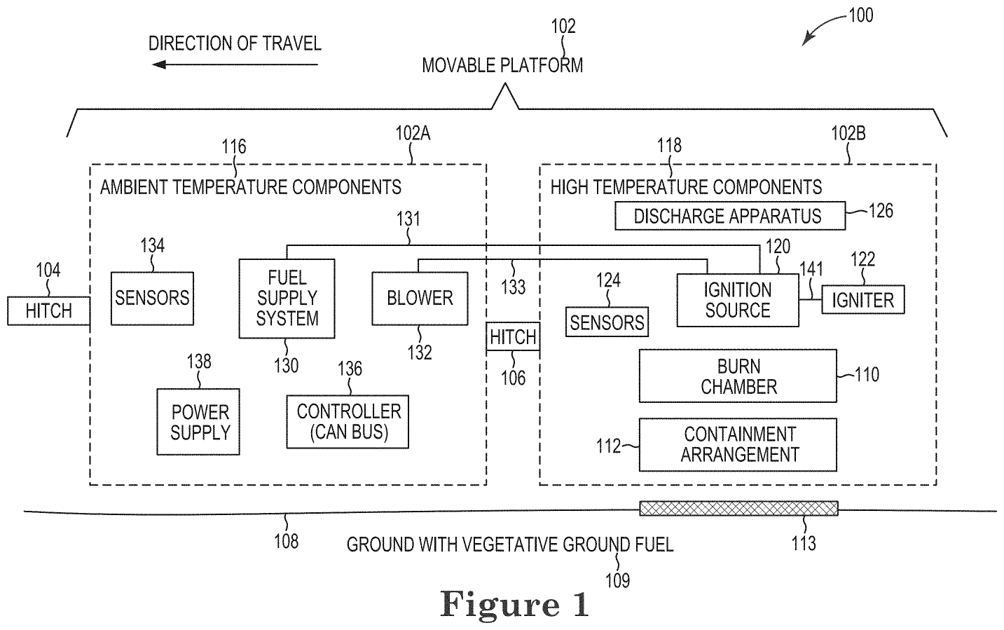

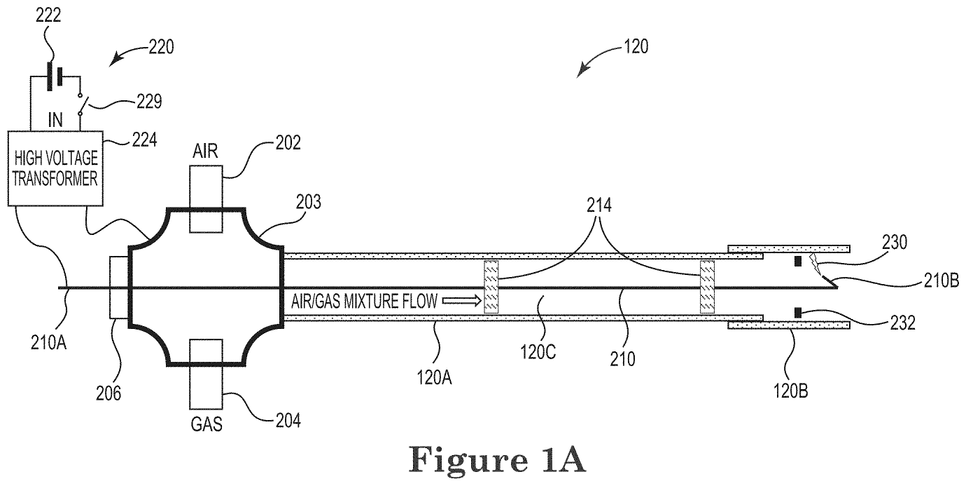

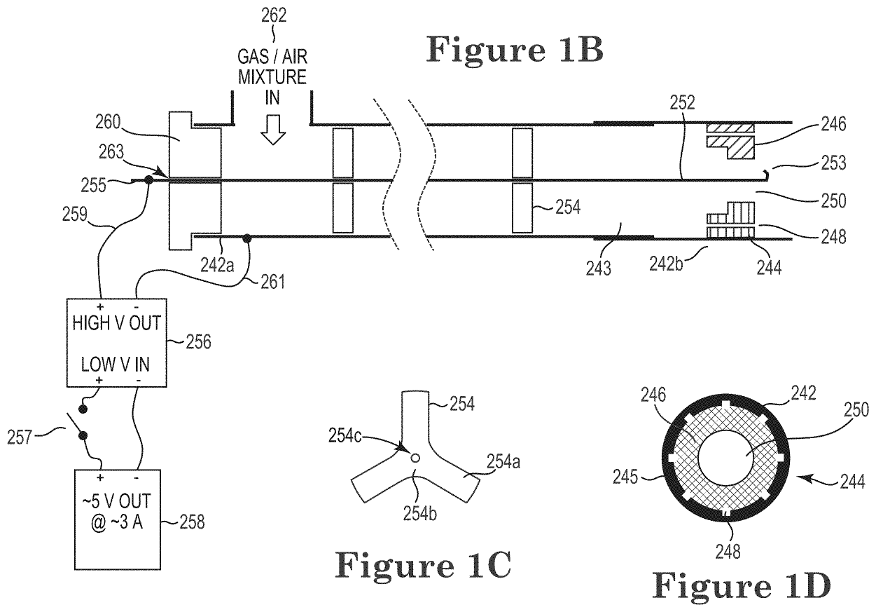

FIG. 1 illustrates an apparatus configured to perform a prescribed burn of vegetative ground fuel in accordance with any of the embodiments disclosed herein. The apparatus shown in FIG. 1 is referred to herein as a PB vehicle 100 which includes a movable platform 102 (e.g., a PB platform) configured to transport components of the apparatus over land 108 which contains vegetative ground fuel 109. The vegetative ground fuel 109 can be any type of vegetative material including, but not limited to, leaves, needles, twigs, brush, small branches, weeds, grass, shrubbery, and agricultural material (e.g., stalks, dead plantings, vegetable material, fruit material). The PB vehicle 100 is configured to traverse ground 108 comprising vegetative ground fuel 109 and perform a prescribed burn of the vegetative ground fuel 109 within a prescribed burn region without a human directly intervening in the prescribed burn. It is understood that, although some embodiments involve hitching a vehicle (e.g., ATV, truck, tractor) to the PB vehicle 100 and/or driving said vehicle, the prescribed burn itself does not require human intervention.

As is shown in FIG. 1, the movable platform 102 supports a number of ambient temperature components 116 and a number of high-temperature components 118. The ambient temperature components 116 are supported by a first movable platform 102a and the high-temperature components 118 are supported by a second movable platform 102b. As shown, the second movable platform 102b is hitched to the first movable platform 102a via a hitch 106. The first movable platform 102a includes a hitch 104 configured to hitch the first and second movable platforms 102a, 102b to a tow vehicle.

As indicated, the first movable platform 102a leads the second movable platform 102b relative to the direction of travel. This arrangement of first and second movable platforms 102a, 102b ensures that the high temperature components 118, which are directly involved in the prescribed burn, remain positioned downstream of the ambient temperature components 116 in the direction of travel. It is understood that the hitches 104, 106 can include electrical, mechanical, fluidic (e.g., fuel, air), and/or hydraulic interconnects in addition to a traditional hitch mechanism (e.g., a ball-type hitch).

The high-temperature components 118 include a burn chamber 110 disposed on the second movable platform 102b. An ignition source 120 is disposed in the burn chamber 110 and configured to ignite vegetative ground fuel 109 within a prescribed burn region 113 on the ground 108. The prescribed burn region 113 defines a region of ground immediately below the burn chamber 110. In other words, the prescribed burn region 113 of the ground 108 is coextensive in area to an area circumscribed by the burn chamber 110.

In various implementations, the movable platform 102 is moved on a continuous basis and at a speed which allows completion of a prescribed burn of ground within the prescribed burn region 113 of the burn chamber 110. As such, vegetative ground fuel 109 which enters the burn chamber 110 is completely burned and rendered inert upon leaving the burn chamber 110. In this manner, the prescribed burn region 113 grows as the burn chamber 110 is moved along the ground 108 as the movable platform 102 traverses the ground 108. In some implementations, the movable platform 102 can be moved across the ground 108 in a step-wise (e.g., start/stop) manner. In such implementations, the movable platform 102 is temporarily halted in a given location in order for the prescribed burn to be performed. Once completed, the movable platform 102 is moved to the next untreated region of the ground 108, and this process is repeated.

As is also shown in FIG. 1, a containment arrangement 112 is situated relative to the burn chamber 110. As will be described in greater detail, the containment arrangement 112 is configured to confine burning of the vegetative ground fuel 109 to the prescribed burn region 113 of the ground 108. A discharge apparatus 126 is positioned relative to the burn chamber 110. The discharge apparatus 126, as will be discussed in greater detail, is configured to expel residual effluent (e.g., residual smoke, greenhouse gasses) from the burn chamber 110. The discharge apparatus, which can include a high-CFM fan, aids with containment of flames and embers by creating an inward airflow at the bottom perimeter of the burn chamber. Various sensors 124, 134, examples of which are discussed below, can be provided to monitor the various ambient and high temperature components 116, 118 and the current environmental conditions of the prescribed burn (e.g., local wind speed, ambient temperature, humidity).

The ignition source 120 can be implemented as any type of heat source that generates heat sufficient to burn vegetative ground fuel 109. In some implementations, the ignition source 120 includes a multiplicity (e.g., an array) of torches 120 each coupled to an igniter 122. The igniter 122 comprises at least one of an electrical discharge igniter, an RF heater, a microwave heater, a laser, and a chemical igniter. The array of torches 120 can be arranged as a single dimensional (e.g., along an x axis) array or a multi-dimensional (e.g., along x and y axes) array. Other ignition sources 120 are contemplated, including a heating filament coupled to an electrical power source and a pilot flame arranged to be ignited by fuel delivered to the burn chamber 110 via a fuel supply system 130 (e.g., a fuel spray arrangement).

According to any of the embodiments which include a multiplicity of torches 120, the torches 120 are situated within the burn chamber 110 and are configured to ignite vegetative ground fuel within a prescribed burn region 113 of the ground 108. In some implementations, all of the torches 120 are directed towards the ground 108. In other implementations, a first set of the torches 120 are directed towards the ground 108, and a second set of torches 120 are directed away from the ground and configured to burn smoke captured within the burn chamber 110. Using torches 120 to burn smoke captured within the burn chamber 110 advantageously reduces the amount of noxious effluent expelled from the burn chamber 110. It is noted that even the torches 120 pointed at the ground also burn the smoke. For example, the torches 120 can produce a long flame such that the hottest part of the torch flame (e.g., the tip of the light blue cone) is above the ground, and is in a position to interact with the rising smoke from the burning vegetation.

FIG. 1A illustrates an implementation of the torch 120 in accordance with any of the embodiments disclosed herein. The torch 120 includes a steel pipe 120a, a torch head 120b, and a void 120c which is fluidically coupled to a manifold 203. The manifold 203 can be implemented as a steel, four-way cross fitting. The manifold 203 includes an air inlet 202 fluidically coupled to an air supply line 133, and a gas inlet 204 fluidically coupled to a fuel supply line 131. The manifold 203 also includes an insulating cap (e.g., plug) 206 which includes a small hole provided therethrough. An igniter wire 210 extends through the hole in the insulating cap 206, through the manifold 203, through the void 120c of the pipe 120a, and terminates at or near the torch head 120b. A small set screw in the head of the insulating cap 206 is used to lock the igniter wire 210 into its optimal position.

The igniter wire 210 is supported within the void 120c of the steel torch pipe 120a by two or more high-temperature, high-voltage insulating supports 214. The insulating supports 214 are made of a material that has a very high dielectric constant so that the insulating supports 214 can hold off high voltages, yet also withstand high temperatures. The insulating supports 214 can be made of a ceramic material, a high-temperature plastic, such as Ultem 1010, or borosilicate glass (e.g., Pyrex®). The igniter wire 210 and the insulating supports 214 are arranged to allow a mixture of air and gas to flow through the void 120c, past the insulating supports 214, and to the torch head 120b.

The igniter supports 214 are configured to allow the air/gas mixture to pass through the void 120c in the torch pipe 120a with minimal obstruction. The igniter supports 214 can either be small-diameter cylindrical posts with a hole in the center for the igniter wire 210, or three (or four) legged “spiders,” again with a small hole in the center for the igniter wire 210. The torch head 120b can include a gas flow splitter and flow control structure 232 upstream of the igniter tip 210b.

The terminal end of the igniter wire 210 includes an igniter tip 210b, which may be a hook or other structure that encourages arcing to occur at that end. These structures can be sharpened to a point to further encourage proper arcing. A proximal end 210a of the igniter wire 210 is connected to an electrical power source 220 via a first electrical conductor 225. A second electrical conductor 227 of the electrical power source 220 is coupled to the steel manifold 203, which is electrically coupled to the torch head 120b via the steel torch pipe 120a. When activated by a switch 229, the electrical power source 220 produces a high-voltage arc at the igniter tip 210b which ignites the air/gas mixture being forced through the torch head 120b. An arc can be repetitively generated at the igniter tip 210b to ensure that the torch 120 remains ignited. According to some implementations, the electrical power source 220 includes a 3-6 VDC power supply coupled to a high-voltage transformer 224 which produces an output voltage of 10,000 V to 40,000 V.

With continued reference to FIGS. 1 and 1A, the fuel supply line 131 is configured to transport a fuel, such as propane gas, from the fuel supply system 130 (e.g., which includes a pressurized fuel tank) to the gas inlet 204 of the manifold 203. The fuel supply system 130 can supply gaseous fuel to the manifold 203 at a specified flow rate. For example, and in a configuration comprising an array of four torches 120 fluidically coupled to four manifolds 203 (or a common manifold 203 is some implementations), the fuel supply system 130 can supply gaseous fuel to the four torches 120 at a flow rate of −1.5 CFM (Cubic Feet Per Minute). It is understood that the fuel flow rate will vary based on several factors, including the length and diameter of the torches 120, the length of the flames, and the temperature of the flames, among others.

The air supply line 133 is configured to transport air from the blower 132 to the air inlet 202 of the manifold 203. The blower 132 is important because the torches 120 are inside the burn chamber 110, and cannot use smokey, dirty air drawn directly from the burn chamber 110. It is noted that having a separately controllable supply of oxygen (air) to the torches 120 with a separately controllable gas supply allows for widely adjustable torch flame temperature, and flame length as needed for various types and densities of vegetation, and burn requirements.

The blower 132 can supply air to the manifold 203 at a specified flow rate. For example, and in the context of the previously discussed configuration comprising an array of four torches 120 fluidically coupled to four manifolds 203 (or a common manifold 203 is some implementations), the blower 132 can supply air to the four torches 120 at a flow rate of about 8 to 12 CFM (e.g., a factor of about 5 to 10 greater than the fuel supply flow rate). It is understood that the air flow rate will vary based on several factors, including the length and diameter of the torches 120, the length of the flames, and the temperature of the flames, among others. Together, the fuel supply system 130 and the blower 132 are configured to transport fuel and air through the torches 120 at a specified flow rate in order to produce a flame at the torch head 120b having a specified length and/or temperature.

It can be appreciated that the design of the torch head 120b is important in order to obtain the desired flame size, shape, and stability as a function of flow rate. The torch head 120b has an internal structure that gives the gas flow the desired properties. It also creates small side flames that are much smaller than the main flame which act as pilot lights to prevent the main flame from blowing out at high gas flow rates, and varying air/gas mixtures.

In general, flames produced by the torches 120 are relatively long flames. Typical flames produced by the torches 120 have a length, L, of about 1 foot to about 3 feet. Those with ordinary skill in the art will appreciate that producing sustained flames from a torch having a length of about 1 foot to about 3 feet is a difficult challenge. Flames having a long length are needed to reach deep into thick vegetative growth/fuel and to provide adequate clearance between the terminal ends of the torches 120 and vegetative ground fuel 109 contained on the ground 108. In addition, the long flame delivers high heat into the space above the vegetative growth which burns the ash and smoke particles, thereby reducing the smoke production before any filtering is performed. Length and temperature of the flames are variable. For example, the temperature of the flames can be varied between about 500° F. to about 3600° F.

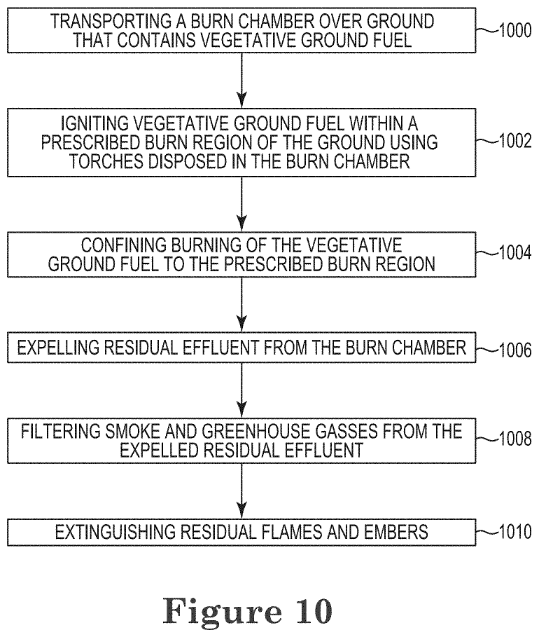

As is further shown in FIG. 1, the ambient temperature components 116 include a power supply 138 (e.g., a generator), various sensors 134, and a controller 136. The controller 136 is configured to execute computer readable instructions (e.g., software and/or firmware) for controlling the operation of the ambient and high temperature components 116, 118 of the PB vehicle 100. For example, the controller 136 can execute computer readable instructions to implement the method shown in FIG. 10.

In some implementations, the controller 136 can be a logic processing component of a Controller Area Network (e.g., a CAN bus). CAN is a robust vehicle bus standard designed to allow controllers (e.g., microcontrollers) and devices to communicate with each other's applications without a host computer. CAN is a message-based protocol. For each device connected to a CAN bus, the data in a frame is transmitted sequentially but in such a way that if more than one device transmits at the same time, the highest priority device can continue while the others back off. Frames are received by all devices, including by the transmitting device. Using CAN, peer stations (controllers, sensors and actuators) are connected via a serial bus. The bus itself can be a symmetric or asymmetric two wire circuit, which can be either screened or unscreened. The electrical parameters of the physical transmission are specified in ISO 11898. Suitable bus driver chips are available from a number of manufacturers.

According to various implementations, the controller 136 can be representative of any combination of one or more logic devices (e.g., multi-core processor, digital signal processor (DSP), microprocessor, programmable controller, general-purpose processor, special-purpose processor, hardware controller, software controller, a combined hardware and software device) and/or other digital logic circuitry (e.g., ASICs, FPGAs), and software/firmware configured to implement the functionality disclosed herein. The controller 136 can incorporate or be coupled to various analog components (e.g., analog front-end), ADC and DAC components, and filters. The controller 136 can be coupled to, or incorporate, memory. The memory can include one or more types of memory, including ROM, RAM, SDRAM, NVRAM, EEPROM, and FLASH, for example.

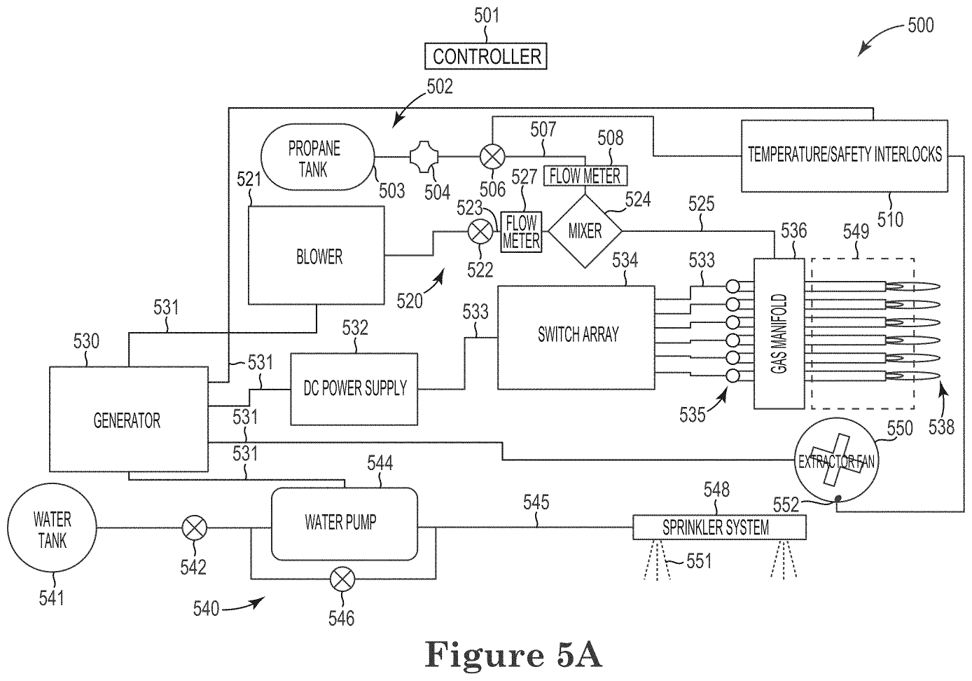

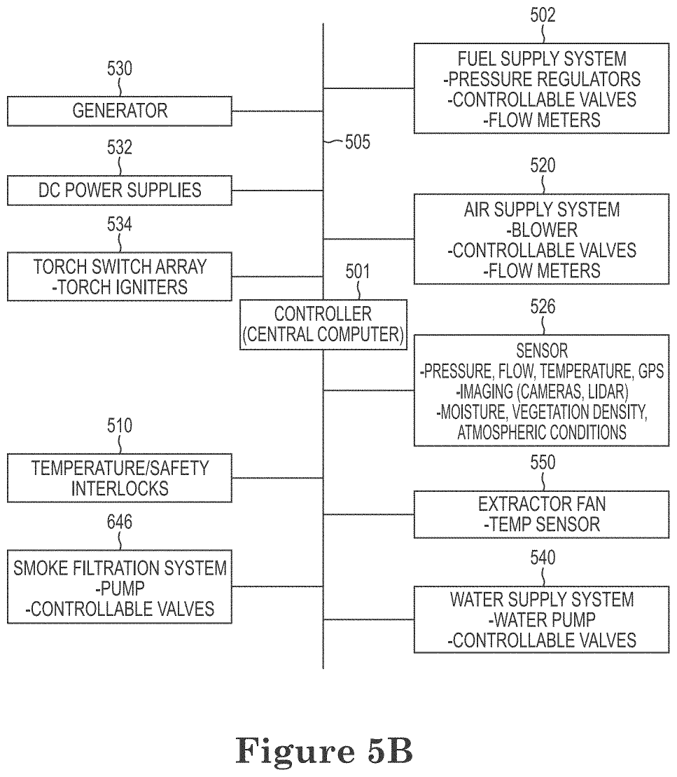

FIG. 1B illustrates an implementation of a torch 240 in accordance with any of the embodiments disclosed herein. The torch 240 includes a torch pipe 242 having a proximal end 242a and a distal end 242b. The torch pipe 242 can be fabricated from steel or other high temperature material. The torch pipe 242 includes an inlet 262 through which a gas/air mixture is introduced into the torch pipe 242. The inlet 262 can be fluidically coupled to a gas manifold which connects to a multiplicity of the torches 240 (see gas manifold 536 in FIG. 5A). An insulating end cap 260 is situated at the proximal end 242a of the torch pipe 242. The insulating end cap 260 is formed from a plastic or other high-dielectric-strength material. The insulating end cap 260 includes a hole 263 provided therethrough.

An igniter wire 252 passes through the hole 263 in the insulating end cap 260 and extends axially through the interior of the torch pipe 242 from the proximal end 242a to the distal end 242b. A number of insulating supports 254 are positioned along the interior of the torch pipe 242 and serve as a support for the igniter wire 252. As is shown in FIG. 1C, the insulating support 254 can have three legs 254a that extend outwardly from a central body 254b. The central body 254b includes a hole 254c through which the igniter wire 252 passes. The insulating supports 254 can be made of a ceramic material, a high-temperature plastic, such as Ultem 1010, or borosilicate glass (e.g., Pyrex®). The igniter supports 254 are configured to allow the air/gas mixture to pass through the void 243 in the torch pipe 242 with minimal obstruction. The igniter wire 252 and the insulating supports 254 are arranged to allow a mixture of air and gas to flow through the void 243, past the insulating supports 254, and to the torch head 244.

The terminal end of the igniter wire 252 includes an igniter tip 253, which may be a hook or other structure that encourages arcing to occur at that end. This structure can be sharpened to a point to further encourage proper arcing. A proximal end 255 of the igniter wire 252 is connected to a high-voltage transformer 256 via a first electrical conductor 259. A second electrical conductor 261 is connected to the exterior surface of the torch pipe 242. The DC power supply (e.g., ˜5V out @˜3 A) 258 is connected to the high-voltage transformer 256 via a switch 257. It is understood that the specific voltage and amperage of the DC power supply 258 depends on specifications of the high-voltage transformer 256. When activated by the switch 257, the high-voltage transformer 256 produces a high-voltage arc at the igniter tip 253 which ignites the air/gas mixture being forced through the torch head 244. An arc can be repetitively generated at the igniter tip 253 to ensure that the torch 240 remains ignited.

FIG. 1D shows an embodiment of the torch head 244 in accordance with various embodiments. The torch head 244 is an insert structure that fits inside or proximate the torch pipe 242 at the distal end 242b. The torch head 244 includes an annular member 245 which supports a gas-flow-shaping insert 246, which may be a solid insert or a wire mesh structure. The torch head 244 also includes a number of radially spaced-apart pilot slots 248. The pilot slots 248 produce smaller flames that keep the torch 240 lit, preventing blow-out, at high gas flow rates. The pilot slots 248 also allow the torch 240 to operate when the air/gas mix is very lean. A central void of the gas-flow-shaping insert 246 defines a primary aperture 250 of the torch head 244. The primary aperture 250, which is reduced in size relative to the inner diameter of the distal end 242b of the torch pipe 242, allows the torch flame to project forward a longer distance, and with high gas velocity, to help drive the flame downwards into the ground fuels. In some implementations, the gas-flow-shaping insert 236 is a solid structure which includes the primary aperture 250 and eight pilot slots 248 around the perimeter of the gas-flow-shaping insert 236.

In various embodiments, it is desirable that the torch 240 produce a high-temperature flame up to about 24 inches long so that the flame can reach the ground from that distance in order to accommodate a ground clearance of about 18 inches or more. The torch 240 is configured to provide adjustment to both the temperature and length of the flame as needed by varying the air flow and gas flow without blowing out over a wide adjustment range. The torch 240 is resistant to heat and flames to a temperature of at least 1200° F. for extended periods, since most of the torch pipe 242 is inside the burn chamber. As previously described, the torch 240 is capable of reliably igniting and then reigniting the flame as needed despite exposure to dirt, dust, ash smoke, and other debris. The construction of the torch 240 makes it resistant to occasional impacts from twigs, stones, stumps, and other obstacles that may enter the burn chamber despite protections that are in front of the PB vehicle.

The coaxial design of the igniter system shown in FIG. 1B protects the igniter components, while ensuring that it works under the difficult conditions encountered during operation in the field. In some implementations, the igniter wire 252 is uninsulated to avoid having a component that can melt or break. In this configuration, the torch pipe 242 should have a minimal inner diameter (e.g., ˜1″) to prevent unintentional internal arcing. Alternatively, the igniter wire 252 can have an insulating coating such as a material having a high-dielectric strength which does not melt or break easily and does not obstruct the flow of the air/gas mixture through the void 243 of the torch pipe 242.

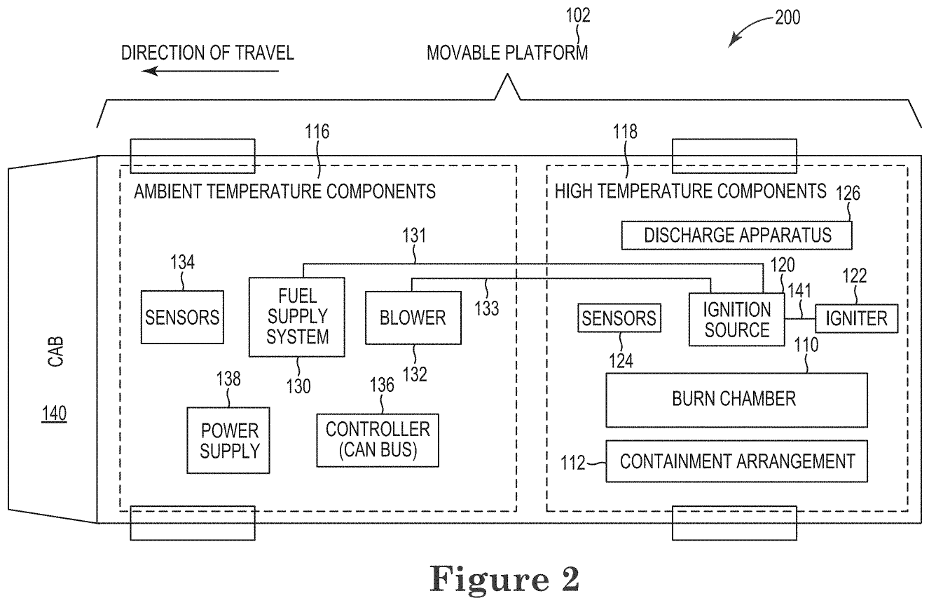

FIG. 2 shows an embodiment of a PB vehicle in accordance with any of the embodiments disclosed herein. The PB vehicle 200 illustrated in FIG. 2 is implemented as a self-propelled moving platform that performs prescribed burning, such as in critical and high-risk areas. As previously discussed, the PB vehicle 200 includes systems that essentially eliminate the risk of escaped fire, and dramatically reduce the amount of smoke that is released into the atmosphere. The PB vehicle 200 can be outfitted with an array of sensors and tracking devices, allowing the PB vehicle 100 to collect extensive data as it does its work.

The PB vehicle 200 includes a number of ambient temperature components 116 and a number of high temperature components 118, all of which are supported by a platform 102 of the PB vehicle 200. The components of the movable platform 102 can be the same as those shown and described with reference to FIGS. 1, 1A, and 1B (and other figures). The PB vehicle 200 can include a cab 140 which includes typical equipment to allow a driver to maneuver the PB vehicle 200 over land which includes vegetative ground fuel 109. In some implementations, the PB vehicle 200 is implemented as an autonomous or remote-control vehicle requiring no driver or tow vehicle, in which case the cab 140 is excluded. As is shown in FIG. 2, and primarily for safety reasons, the ambient temperature components 116 are situated proximate the cab 140, while the high temperature components 118 are situated away from the cab 140 in a position that follows the ambient temperature components 116.

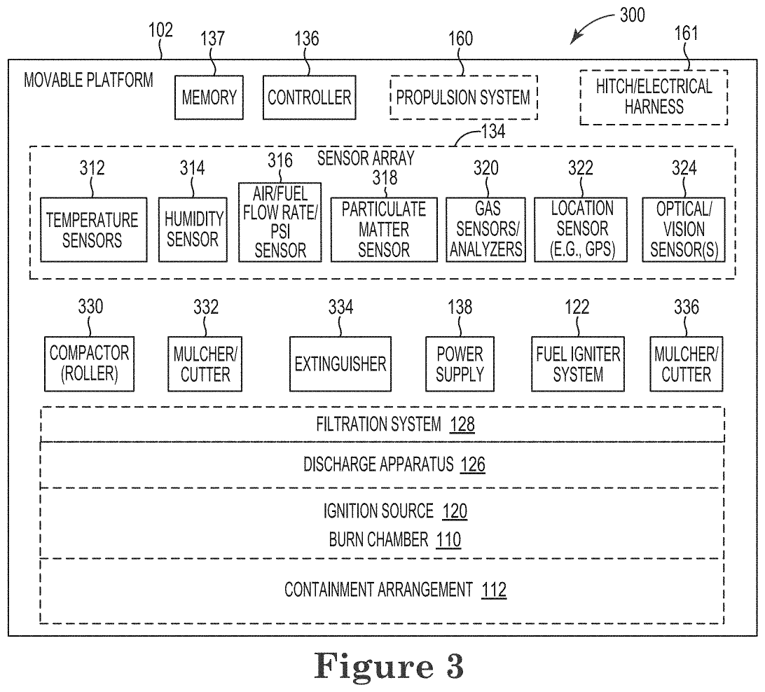

FIG. 3 illustrates a PB vehicle 300 which includes a movable platform 102 that supports the components configured to perform a prescribed burn of vegetative ground fuel in accordance with any of the embodiments disclosed herein. As previously discussed, the movable platform 102 includes some or all of the components shown in FIGS. 1, 1A, 1, and 2. For example, the movable platform 102 shown in FIG. 3 supports a burn chamber 110, an ignition source 120, fuel igniter system 122, a containment arrangement 112, a discharge apparatus 126, and a smoke filtration system 128, details of which are provided below. A power supply 138 (e.g., a generator) provides power to the various power-consuming components of the PB vehicle 300, which include DC power supplies. A compactor 330 (e.g., a heavy roller) can be included inside and/or outside of the burn chamber 110. A first mulcher/cutter 332 can be provided ahead of the entrance to the burn chamber 110, and/or the second mulcher/cutter 336 can be provided near the exit of the burn chamber 110.

In some implementations, the PB vehicle 300 includes a propulsion system 160 (e.g., an electric or a gasoline/diesel propulsion system) for propelling the movable platform 102 along land containing vegetative ground fuel 109. In other implementations, the PB vehicle 300 excludes a propulsion system 160, and includes a hitch 104 which can include an electrical harness 161 configured to electrically communicate with components of a tow vehicle coupled to the hitch 104. The PB vehicle 300 also includes a controller 136 operatively coupled to memory 137 and one or more sensors 134.

A wide variety of sensors 134 can be supported by the movable platform 102 for monitoring various processes and conditions of the PB vehicle 300. The array of sensors 134 can include one or any combination of one or more temperature sensors 312, humidity sensor 314, air flow rate, fuel flow rate, air pressure, fuel pressure (PSI) sensors 316, particulate matter sensor 318, one or more gas sensors/analyzers 320, a location sensor 322 (e.g., a GPS, GPS-RTK), and optical/vision/imaging sensors 324 (e.g., a camera positioned to view the burn chamber/torch flames via a Pyrex® window). In the case of an autonomous vehicle implementation, the sensors 134 can include autonomous vehicle proximity and ranging sensors, such as radar, sonar, ultrasound, and LIDAR.

The following is a non-exhaustive list of additional sensors that may be incorporated in the PB vehicle 300 in accordance with any of the embodiments disclosed herein. As previously discussed, the sensors 134 can include temperature sensors 312 (e.g., multiple, in various locations inside and outside of the burn chamber), which can include one or more thermocouples, IR remote sensors, thermistors, RTD (Resistive Temperature Detection) sensors, and bi-metal sensors. One or more sensors can be implemented to monitor and aid in control of torch temperature, monitor burn chamber temperature, monitor fuel (vegetation) and soil temperature before, during and after a prescribed burn. Temperature sensors 312 can be deployed to monitor temperature of various PB vehicle components including, but not limited to, torch components, burn chamber sides, fan temperature, and temperature of expelled gasses.

The PB vehicle sensors 134 can include one or more smoke particulate emission sensors 318, such as PM 2.5 and PM 10 sensors. The PB vehicle sensors 134 can include one or more greenhouse gas emission sensors 320, such as CO, CO2, and methane sensors. Various chemical effluence sensors can be deployed on the PB vehicle 300.

The PB vehicle sensors 134 can include one or more optical sensors and IR cameras 324 (e.g., multiple, in various locations to monitor and record both inside and outside the PB vehicle 300). The optical sensors and IR cameras 324 can be implemented to monitor torch performance (e.g., torch flame length and temperature (colorimetry)), monitor and record vegetation flame height, consistency and other flame properties, evaluate completeness of the burn (e.g., fuel consumption), and check for left-over flames or embers to extinguish.

Various sensors 134 can be included on the PB vehicle 300 for controlling and tracking PB vehicle position and motion, such as for remote or autonomous control. As previously discussed, such sensors 134 can include one or more of optical and IR cameras 324, radar, LIDAR, ultrasonic sensors, GPS 322, inertial navigation (gyros, MEMS, laser, or spinning), and an odometer.

The PB vehicle sensors 134 can include one or more moisture and other fuel (vegetation) property sensors. Such sensors 134 can include multispectral or hyperspectral imaging cameras, microwave sensors, and RF sensors. These and other sensors can be implemented to measure moisture level in the fuel (vegetation), moisture in the soil, and moisture in the atmosphere within and outside of the burn chamber.

For example, the PB vehicle sensors 134 can include sensors for determining vegetation type (e.g., situated at the front of the PB vehicle 300). The PB vehicle sensors 134 can include a sensor for determining vegetation density before burning (e.g., situated at the front of PB vehicle 300). The PB vehicle sensors 134 can include a sensor for determining residual (left-over) vegetation density after burning (e.g., situated at the rear of PB vehicle 300). These sensors can be implemented using image/camera based sensors, such as a color imaging sensor, a LIDAR sensor, a hyperspectral imaging sensor, or other type of optical sensor.

The PB vehicle sensors 134 can also include one or more other sensors, such as flow meters for air and gas input to torches and pressure gauges 316 for the air blower and gas lines, a fan speed tachometer, an air flow sensor 316, an anemometer/weathervane to monitor external wind speed and direction, an outside air temperature sensor 312, and an outside humidity sensor 314.

Any or all of the data collected by the various PB vehicle sensors 134 can be stored in the memory 137 coupled to the controller 136. Any or all of the data collected by the various PB vehicle sensors 134 can be stored in a central server communicatively coupled to the controller 136 (e.g., accessed via a wireless transceiver and a network access point coupled to the Internet) to be accessed by fire departments, the USGS, the EPA and other public and private agencies, and can also be correlated with mapping services such as Google Geospatial.

The sensors 134 are operatively coupled to, and monitored by, the controller 136. The controller 136, which can be a computer, processor or other logic device, can be configured to control and adjust any of the processes implemented by the ambient and high-temperature components 116, 118 of the movable platform 102. For example, the controller 136 can be configured to adjust the speed/CFM of the blower 132 and/or pressure/flow rate of the fuel supply system 130 to produce torch flames of a prescribed length (e.g., 2 feet or 3 feet in length) and/or temperature, control fan speed, and movement of the PB vehicle, etc. The controller 136 can either be implemented as, or be communicatively coupled to, a central computer system which can also log all the data from the sensors, and provide a dashboard that is continuously updated. Data acquired by the controller 136 can be communicated to an external electronic device (e.g., a tablet, laptop, smartphone, cab display), which can display the data to the operator of the PB vehicle.

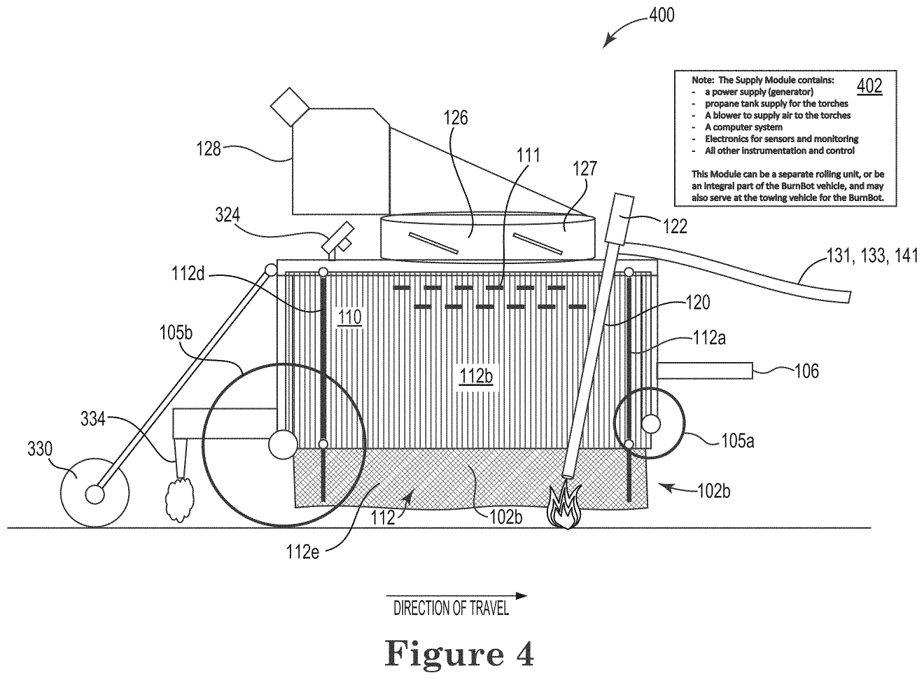

FIG. 4 illustrates an embodiment of a PB vehicle in accordance with any of the embodiments disclosed herein. The PB vehicle 400 includes a movable platform 102b having a towing hitch 106. The movable platform 102b is supported above the ground by a frame which supports a rear wheel arrangement 105b. In some implementations, the rear wheel arrangement 105b includes large diameter (e.g., 36″ minimum), soft, balloon-type wheels. A front wheel arrangement 105a comprising smaller diameter wheels can be included. The front wheel arrangement 105a can include casters that can rotate. The casters can be adjustable (e.g., retractable) in height. For example, once lifted, the casters can be positioned at the correct height to prevent the torches 120 from bottoming out if a large bump or dip in the train is encountered. The front wheel arrangement 105a keeps the burn chamber 110 from hitting the ground on uneven and rough terrain (e.g., large bumps and ditches), and makes turning and traveling up or down slopes easier. The front wheel arrangement 105a also supports the front of the PB vehicle 400, and allows it to roll easily, when the PB vehicle 400 is disconnected from its towing vehicle. In some implementations, the PB vehicle 400 can have a three-point stance with a ball-type hitch at the towing vehicle, making it stable and flexible on uneven terrain.

The PB vehicle 400 illustrated in FIG. 4 includes the high temperature components 118 shown in FIGS. 1, 1A, 1, and 2 situated on the movable platform 102b. The towing hitch 106 can be configured to couple the movable platform 102b to a movable platform 102a supporting the ambient temperature components 116 or to a tow vehicle which supports the ambient temperature components 116 in the form of a supply module 402. In the representative illustration shown in FIG. 4, the supply module 402 includes a power supply 138 (e.g., a generator), a propane tank supply (e.g., fuel supply system 130) for the torches 120, a blower 132 to supply air to the torches 120, a water tank supply to support a sprinkler/extinguisher arrangement, a computer system comprising the controller 136 (e.g., a CAN controller), electronics for sensors 134 and monitoring, and all other instrumentation and control components.

FIG. 4 is a sectional side-view of the PB vehicle 400 which includes the burn chamber 110 and the containment arrangement 112. The containment arrangement 112 includes a front door 112a comprising a metal sheet which is hinged one or more places to allow ground fuel 109 to enter the burn chamber 110. The containment arrangement 112 also includes a rear door 112d comprising a metal sheet which is hinged in one or more places to allow burnt ground fuel 109 to exit the burn chamber 110. The containment arrangement 112 further includes opposing sides 112b, 112c (not shown) each comprising solid sheet metal. A non-flammable skirt 112e, which may be perforated (semi-porous) or solid, extends from the lower section of the sheet metal 112a-d to a location at or slightly above ground level. The non-flammable skirt 112e, which may include a chain mail skirt and/or a skirt formed from carbonized felt or silica cloth, provides for ingress of air into the burn chamber 110 (e.g., a leaky lower chamber) as well inhibiting embers, flames, and debris from exiting the burn chamber 110.

FIG. 4 shows a discharge apparatus 126 mounted to the top surface of the burn chamber 110. The top surface of the burn chamber 110 includes an opening over which the discharge apparatus 126 is situated. The discharge apparatus 126 is shown to include a high-temperature ducted extractor fan 127, which may alternatively be implemented as a tube axial fan or a venturi. The fan 127 is configured to expel residual effluent (e.g., smoke, greenhouse gasses) from the burn chamber 110. The fan 127 also creates upwardly directed airflow that draws air into the burn chamber 110 at its bottom edge, and increases the concentration of oxygen at ground level, moves smoke and effluent gasses upward through the burn chamber 110 and out the discharge apparatus 126, and creates an airflow pattern that prevents ashes and embers from shooting back into the burn chamber 110 or onto the ground (e.g., creates a negative pressure in the burn chamber 110). It is noted that an air gap is provided between the non-flammable skirt 112e and the ground (about the perimeter of the burn chamber 110) that can be selected to match the flow rate of the extractor fan 127 so the inward air flow velocity serves to contain the flames and embers.

A camera can be situated near a viewing port (e.g., a Pyrex® port) to look into the burn chamber 110. In some implementations, the viewing apparatus includes an uncooled temperature-hardened camera (typically takes up to ˜200° F.) or an air or water-cooled camera system (can take higher temperatures up to ˜2000° F.), and a manifold that encloses the camera with a viewing port into the burn chamber 110. The manifold can have an insulating connection to the camera (e.g., ceramic connection), and can also have intentional air leaks that allow cool air from the outside to be drawn into the manifold just in front of the camera lens. This air can be drawn in by the extractor fan 127, and causes cooling, as well as inward air flow that will work against any flames and hot air coming up from the chamber that can threaten the camera.

In some implementations, the discharge apparatus 126 may include a filtration system 128 configured to filter smoke and greenhouse gasses from the effluent expelled from the burn chamber 110 by the fan 127. Although far less smoke is produced by the PB vehicle 300 because the burning is done at high temperature, and the torches 120 also partially burn the smoke particles just above the flames, this additional filtration system 128 at the exhaust side of the fan 127 is desirable, and is designed to remove particulates, including smoke, ash and dust with emphasis on removing harmful smoke in the particle size range of 2.5 to 10 microns (PM 2.5 and PM 10); and remove harmful chemical vapors and greenhouse gasses such as CO, CO₂, methane and others the extent that is practical. Removal of 100% of either smoke or chemical vapors is ideal, but is not necessary because even partial removal is still of value both for health and safety, and for minimizing the environmental impact of burning.

The PB vehicle 400 can incorporate a number of filtering and abatement technologies that may be used alone, or in combination with each other, examples of which are discussed in detail below. These technologies include, but are not limited to, additional torches 120 to further burn smoke and ash particles, traditional sieve-type filters that trap particles larger than a specific size, and cyclonic (centrifugal) filters that use a rotational vortex to force larger particles out of the main airflow. Other technologies include liquid bubbler smoke and/or chemical filter that bubbles the contaminated air through the liquid (e.g., water, a special solvent, or a combination of solvents) leaving particulates trapped in the liquid, and chemical molecules dissolved in the liquid (e.g., CO₂ dissolves in cold water). For example, noxious nitrogen compounds (e.g., denoted as NOx) are soluble in urea, and urea can be implemented in a liquid filtering system.

Further technologies include liquid curtain smoke and/or chemical filter that blows the contaminated air into a “curtain” of flowing liquid that traps the particulate matter, and absorbs chemical molecules into the liquid, which carries the material down into a reservoir. Additional technologies include a liquid mist filter that creates a mist of fine liquid droplets and forces them to mingle with the particulates and chemical molecules in the contaminated air so that they are trapped in the droplets, which eventually fall down into a reservoir.

Other filtering and abatement technologies include an electrostatic filter that applies a static electric charge to the particulates and chemical molecules as they pass through, and then attracts them to stick to oppositely charged plates to remove them from the main airflow. Another technology is an aggregation type filter that force lighter small particles to interact with each other, causing them stick together and become heavier, which in turn causes them to fall down into a collection chamber, removing them from the main exhaust airflow. The aggregation effect can be created using one or more of several methods:

Various filtering and abatement technologies that can be incorporated by the PB vehicle 400 are configured to expose the particles to pressure waves (such as sound waves) that oscillates them, and causes them to collide with each other, drive the air through nozzles that force the particles to interact with each other, and/or create turbulent airflow causing the particles to interact with each other. Additional filtering and abatement technologies include gravitational filters which control the air flow speed, and cause the airflow to travel a long distance while allowing gravity to pull particulates out of the airflow and fall down into a collection chamber.

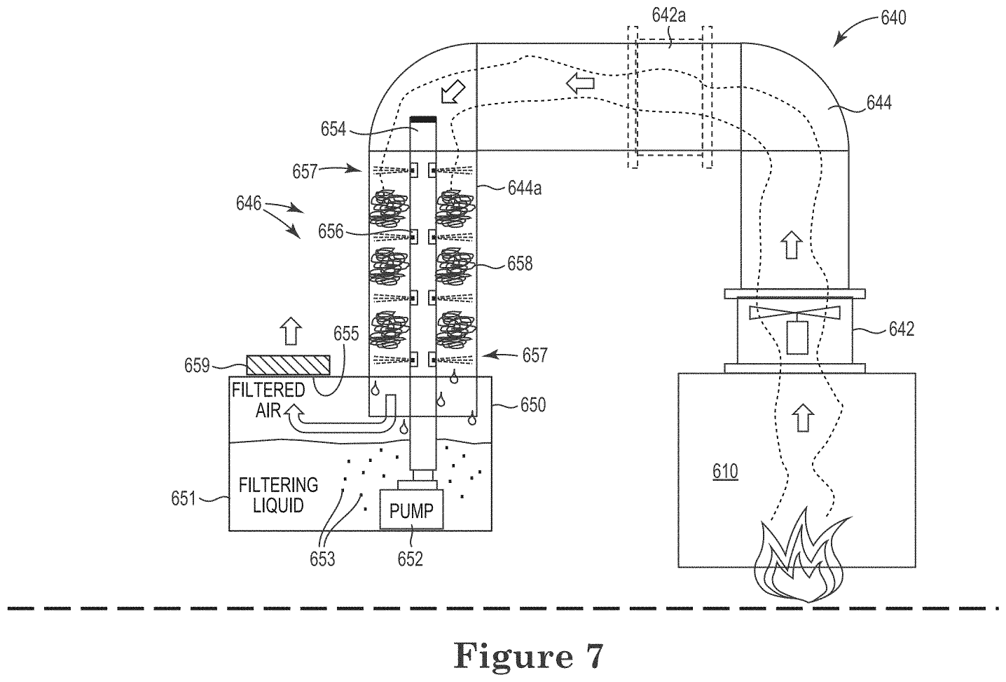

These filtering technologies may be used alone, or together either in series or in parallel, depending on what works best for the given conditions and byproducts of the fuel type and burn process. Also, multiple stages of the same filter type may be used in series with each stage extracting some portion of the unwanted particulates or chemical molecules, thereby increasing the overall efficacy of the system by repeatedly processing the contaminated air. This can be done by using copies of the same filter type in series, or by using the same filter, but forcing the contaminated air to pass through it multiple times. A representative smoke filtration system is illustrated in FIG. 7, details of which are provided below.

The containment arrangement 112 can include perforated heat shields 111 arranged to block a direct path of flames and debris to the discharge apparatus 126. The heat shields 111 can comprise two or more sheet metal plates. The sheet metal plates can be vertically spaced from one another and include offset holes or another arrangement of staggered apertures.

In some implementations, the PB vehicle 400 includes an extinguisher 334 which can be positioned at or proximate the rear door 112d of the containment arrangement 112. In some configurations, the extinguisher 334 can be situated within the burn chamber 110. The extinguisher 334 can be configured to spray water or liquid nitrogen to prevent reignition and side creep burning outside of the burn chamber 110. A compactor 330, such as a heavy roller, can be situated proximate an exit of the burn chamber 110, such as behind the rear door 112d. Although not shown in FIG. 4, a mulcher or cutter can be situated proximate the exit of the burn chamber 110 which can crush and aid in extinguishing spent ground fuel. In some implementations, a mulcher or cutter can be situated proximate the entry of the burn chamber 110, such as in front of the front door 112a, and configured to cut up vegetative ground fuel ahead of the PB vehicle 400.

FIG. 5A is a schematic of various components of a PB vehicle in accordance with any of the embodiments disclosed herein. The PB vehicle 500 illustrated in FIG. 5A includes a fuel supply system 502 which comprises a fuel tank 503 fluidically coupled to a pressure regulator 504, a controllable valve 506, and a flowmeter 508. These components are connected, and fluidically coupled to, a mixer 524 via a gas line 507. An air supply system of the PB vehicle 500 includes a blower 521 (e.g., a regenerative blower) which supplies air to the torches 538 via a controllable valve 522, air line 523, flow meter 527, and mixer 524. An air/fuel mixture is communicated from the mixer 524 to a gas manifold 536 via air/fuel mix line 525.

In some implementations, the gas manifold 536 is coupled to all of the torches 538, in which case the temperature, flame size, and projection of the flames is controlled for the group of torches 538 by adjustment of air and gas flow to the gas manifold 536. In other embodiments, the temperature, flame size, and projection of the flame for the torches 538 is controlled by independent adjustment of air and gas flow to each torch or torch array separately. In such embodiments, each individual torch 538 or torch array can be fluidically coupled to its own set of controllable valves 506, 522, flow meters 508, 527, and mixer 524. It is understood that individual control of the torches 538 involves separate control of the airflow and gas flow to each torch 538 or torch array.

A DC power supply 532 provides power to the torch igniters 535 via a switch array 534. The switch array 534 includes individual triggers for activating each of the torch igniters 535. The DC power supply 532, switch array 534, and torch igniters 535 are connected via DC/low voltage connections 533.

The PB vehicle 500 includes an extractor fan 550, which is arranged to expel residual effluent (e.g., residual smoke, greenhouse gasses) from the burn chamber 549. The PB vehicle 500 may include more than one extractor fan 550 such that each extractor fan 550 is individually controlled to achieve the best flame and ember containment, and capture of smoke. The extractor fan 550 includes a temperature sensor 552, such as a thermocouple, for monitoring fan temperature. Temperature/safety interlocks 510 are coupled to the temperature sensor 552 and the controllable valve 506 of the fuel supply system 502. The temperature/safety interlocks 510 protect the extractor fan 550 from overheating by decreasing or shutting off the flow of fuel to the gas line 507.

The PB vehicle 500 also includes a water supply system 540 which includes a water tank 541 fluidically coupled to a water pump 544 via a controllable valve 542 and a water line 545. The water pump 544 can include a shunt valve 546 for controlling the output water pressure. In some implementations, water pressure can be controlled electronically by adjusting the water pump motor speed or stroke length of its piston, depending on the type of water pump 544 used.

The water tank 541 and water pump 544 are fluidically coupled to a sprinkler system 548. The sprinkler system 548 can include sprinklers 551 positioned within the burn chamber 549. Additionally, the sprinkler system 548 can include sprinklers 551 positioned on the exterior of the PB vehicle 500, such as near an exit of the burn chamber 549. The sprinklers 551 and sprinkler system 548 are used to both extinguish any residual flame or embers, and help prevent any escaped fire at the rear or sides preemptively. The sprinklers 551 and sprinkler system 548 can be used to spray water, fire retardant solution, liquid nitrogen (LN2), carbon dioxide in solid particulate form or as a gas, or any other suitable fire suppression material. A generator 530 supplies AC power to various components of the PB vehicle 500. As is shown in FIG. 5A, the generator 530 supplies power to the temperature/safety interlocks 510, blower 521, DC power supply 532, extractor fan 550, and water pump 544.

According to various embodiments, the systems shown in the schematic of FIG. 5A can be under the control of a controller 501, which may be implemented as a central computer, processor or other logic device. For clarity, connections between the controller 501 and individual components shown in FIG. 5A are omitted. The controller 501 provides for on-the-fly adjustment of the various systems shown in FIG. 5A as needed by the vegetation and terrain.

FIG. 5B is a block diagram of a control system of a PB vehicle in accordance with any of the embodiments disclosed herein. The controller 501 is communicatively coupled to a number of components via a communication bus 505. The communication bus 505 can include a CAN bus, for example. As is shown in FIG. 5B, the controller 501 is communicatively coupled to the fuel supply system 502, including pressure regulators 504, controllable valves 506, and flow meters 508. The controller 501 can be configured to control the supply of fuel to each torch array (e.g., individually or as a group) or each individual torch 538. For example, the controller 501 can cooperate with torch status monitors for determining the temperature and flow rate or gas velocity of each torch 538 or each torch array and whether or not each torch 538 is lit. In some implementations, the PB vehicle 500 can include a number of fuel supply systems 502 corresponding to the number of torch arrays, one for each of the array of torches 538. In other implementations, each of the array of torches 538 shares a common propane tank 503, but each can have a dedicated controllable pressure regulator 504, controllable valve 506, flow meter 508 and mixer 524.

The controller 501 is communicatively coupled to the air supply system 520, which includes the blower 521 (e.g., for controlling blower speed), controllable valves 522, and flow meters 527. The controller 501 can be configured to control the supply of air to each torch array (e.g., individually or as a group) or each individual torch 538. In some implementations, the PB vehicle 500 can include a number of air supply systems 520 corresponding to the number of torch arrays, one for each of the array of torches 538. In other implementations, each of the array of torches 538 shares a common blower 521, but each has a dedicated controllable valve 522, flow meter 527, and mixer 524.

The controller 501 is communicatively coupled to the water supply system 540 of the PB vehicle. For example, the controller 501 is coupled to the water pump 544 and controllable valves 542, 546. The controller 501 can be configured to control the supply of water dispensed from the water tank 541 to the sprinkler system 548 by controlling the valves 542, 546. For example, the shunt valve 546 can be controlled to increase (e.g., by closing valve 546) and decrease (by opening valve 546) the volume of water delivered to the sprinkler system 548.

In some implementations, a multiplicity of independently controlled sprinklers 551 can be provided for extinguishment. These sprinklers 551 can be controlled separately by the controller 501 to turn on only as needed to extinguish a small flame or hot spot in a particular location without having to spray a larger area. The control of each sprinkler can be guided by the FLTR camera at the rear (or elsewhere) of the PB vehicle which can identify not only flames, but also embers and hot spots. This independent sprinkler control can be useful for minimizing the use of water which can be costly or difficult to supply in large quantities during field operations.

The extractor fan 550 is communicatively coupled to the controller 501, as is temperature sensor 552 disposed in or proximate the extractor fan 550. The speed of the extractor fan 550 can be controlled by the controller 501 depending on a number of factors, including the burn rate of vegetative material in the burn chamber 549 and the rate at which the smoke filtration system 646 can effectively process effluent smoke and gases received from the burn chamber 549. The temperature sensor 552 of the extractor fan 550 is coupled to the temperature/safety interlocks 510 to protect the extractor fan 550 from overheating, as previously discussed. It is noted that various safety interlocks may be redundant for reliability, and may be both controlled/monitored by the controller 501, as well as being independent hardware systems.

As is also shown in FIG. 5B, the controller 501 is communicatively coupled to the generator 530, and the various DC power supplies of the PB vehicle. For example, the controller 501 is coupled to DC power supply 532, switch array 534, and torch igniters 535 shown in FIG. 5A. Under control of the controller 501, the switch array 534 individually triggers each torch igniter 535 for igniting individual torches 538.

The controller 501 is communicatively coupled to various sensors 526 of the PB vehicle. The various sensors 526 include, but are not limited to, pressure, flow, temperature, and imaging (e.g., standard cameras, IR cameras) sensors. Other sensors include moisture, vegetation density, and atmospheric conditions sensors (e.g., wind velocity and direction, humidity). A GPS sensor and other positioning, tracking, and motion control systems can be coupled to/controlled by the controller 501.

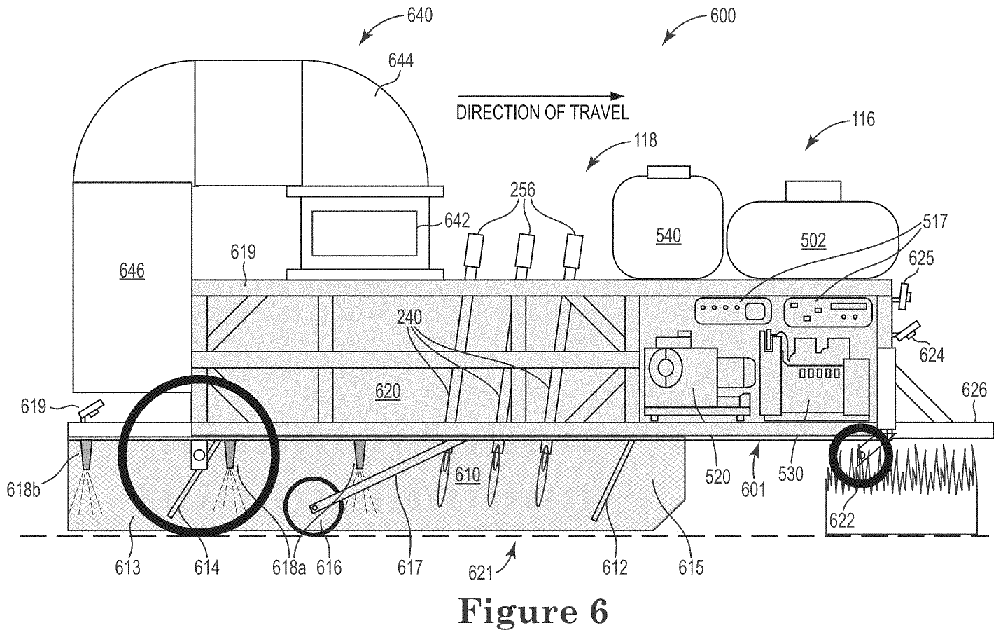

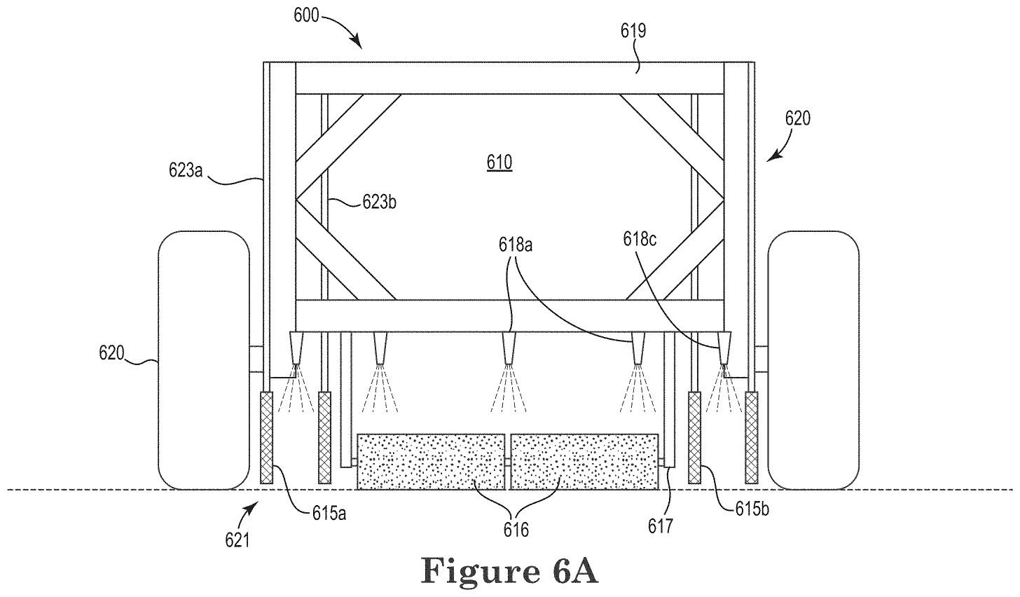

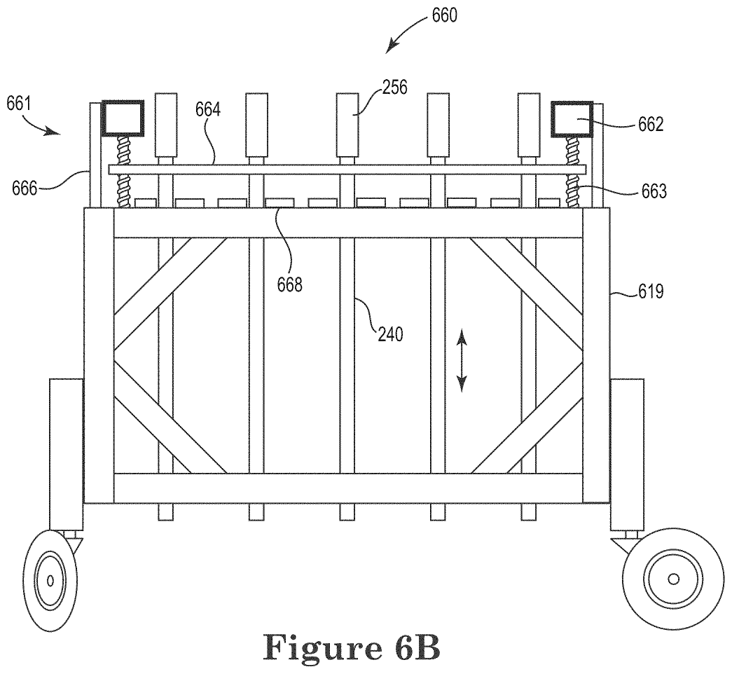

FIG. 6 illustrates a PB vehicle in accordance with any of the embodiments disclosed herein. The PB vehicle 600 shown in FIG. 6 includes a movable platform 601 which supports the ambient temperature components 116 in the front of the movable platform 601. High temperature components 118 are supported in the middle and rear of the movable platform 601 following the ambient temperature component 116 in the direction of travel. The movable platform 601 includes main wheels 613 situated towards the rear of the platform 601 and smaller wheels 622 (e.g., casters) situated towards the front of the platform 601. As previously discussed, the main wheels 613 can be soft, balloon type wheels.

The movable platform 601 includes a hitch 626 for coupling the movable platform 601 to a tow vehicle. The tow vehicle can be a manually controlled, remote control, or fully autonomous tractor. Suitable remote control tow vehicles are commercially available (e.g., Green Climber, Dronester, Ztractor, Honda Autonomous Work Vehicle). The tow vehicle can also be a bulldozer, farm tractor, or other appropriate vehicle. Implementing the PB vehicle 600 as a towed vehicle provides flexibility, and allows towing by various machinery that is used in forestry and farming. This approach alleviates the necessity to design, develop, and build a drivetrain, and remote or autonomous control for the PB vehicle 600. Implementing the PB vehicle 600 as a towed vehicle allows the vehicle 602 access very steep inclines, if necessary, by having a separate towing vehicle with a winch at the crest of a hill to tow the PB vehicle 600 up and down the hill via the winch.

The ambient temperature components 116 include a fuel delivery system, including a fuel tank 503, a water supply system, including a fuel tank 503, air delivery system, including a blower 521, and a generator 530. These systems can include the components described above with reference to FIG. 5A. The PB vehicle 600 includes electronics 517, which include a controller (e.g., a central computer) and temperature/safety interlock systems, among other components. One or more cameras 624, 625 can be situated at the front and sides of the movable platform 601. The cameras 624, 625 can be configured to facilitate PB vehicle guidance, obstacle avoidance, and measurement of vegetation.

The high temperature components 118 of the PB vehicle 600 include a burn chamber 610 comprising an upper enclosure 620 and a lower enclosure 621. The upper enclosure 620 includes a frame 619 wrapped by sheet metal. The frame 619 can be made of a suitable high temperature metal, such as stainless steel. The lower enclosure 621 extends from the bottom of the frame 619 and towards the ground. The lower enclosure 621 includes a flexible fireproof containment skirt 615, a front swinging door 612, and a rear swinging door 614. Suitable material for the fireproof containment skirt 615 includes chain mail, silica cloth (e.g., White Spark™ supplied by Steel Guard Safety Products, Inc.), and carbonized felt (e.g., Knight Armor™ supplied by Steel Guard Safety Products, Inc.) A number of internal sprinklers 618a are supported by the frame 619, situated within the burn chamber 610, and directed towards the ground. One or more external sprinklers 618b can be situated outside of the burn chamber 610 and positioned proximate the rear swinging door 614.

FIG. 6A illustrates an embodiment of a burn chamber 610 in accordance with any of the embodiments disclosed herein. FIG. 6A is a rear view of the PB vehicle 600. For purposes of clarity, the swinging front and rear doors 612, 614 and torches 240 are not shown in FIG. 6A. The burn chamber 610 includes a frame 619 that supports an outer panel 623a and an inner panel 623b, both of which are preferably formed from sheet metal. The outer and inner panels 623a, 623b define the upper enclosure 620 of the burn chamber 610. Connected to, and extending from, the outer panel 623a is an outer containment skirt 615a. Connected to, and extending from, the inner panel 623b is an inner containment skirt 615b.

The outer and inner containment skirts 615a, 615b define the lower enclosure 621 of the burn chamber 610, and are formed from flexible fireproof material. Suitable flexible fireproof material includes chain mail, silica cloth (e.g., White Spark™ supplied by Steel Guard Safety Products, Inc.), and carbonized felt (e.g., Knight Armor™ supplied by Steel Guard Safety Products, Inc.). The combination of the outer and inner panels 623a, 623b and outer and inner containment skirts 615a, 615b provides a double barrier that serves to essentially eliminate the risk of escaped fire from the burn chamber 610. The outer panel 623a and outer containment skirt 615a provides additional insulation from the heat in the burn chamber 610 for both better containment and safety of both personnel and equipment. It is noted that the outer and inner panels 623a, 623b can be made of the same, or different, materials. The outer and inner containment skirts 615a, 615b can be made of the same, or different, materials. It is also noted that, in some implementations, only one of the outer and inner panels 623a, 623b and one of the outer and inner containment skirts 615a, 615b can be provided.

FIG. 6A shows a number of internal sprinklers 618a mounted to the frame 619 and positioned within the burn chamber 610. FIG. 6A also shows interstitial sprinklers 618c mounted to the frame 619 and positioned between the outer and inner panels 623a, 623b, which adds greatly to the efficacy of the fire/ember containment system. As previously discussed, external sprinklers can be situated on the frame 619 outside of the outer and inner panels 623a, 623b and outer and inner containment skirts 615a, 615b (e.g., on both sides of the frame 619). The sprinklers 618a, 618c and sprinkler system are used to both extinguish any residual flame or embers, and help prevent any escaped fire at the rear or sides of the PB vehicle 600 preemptively. The sprinklers 618a, 618c and sprinkler system can be used to spray water, fire retardant solution, liquid nitrogen (LN2), carbon dioxide in solid particulate form or as a gas, or any other suitable fire suppression material. In the case of only a single panel 623a, 623b and a single containment skirt 615a, 615b, the locations of the sprinklers may be as shown in FIG. 6A, either inside or outside of the containment skirt 615a, 615b or both, depending on the best design for the application.

A heavy roller 616 is mounted to a roller pivot arm 617 and positioned within the burn chamber 610. The roller pivot arm 617 is mounted to the frame 619. As shown, the heavy roller 616 is a split roller comprising first and second heavy rollers. It is noted that internal sprinklers 618a can be situated on the frame 619 ahead of, and behind, the heavy roller 616.

With continued reference to FIGS. 6 and 6A, the heavy roller 616 is configured to break down and compress any partially burned material to reduce oxygenation and future risk of ignition. The heavy roller 616 is an effective aid in quelling fire or embers that are left over by the torches 240. The weight of the heavy roller 616 compresses and starves oxygen, and the high heat capacity cools the fuel. The heavy roller 616 can be solid or filled with water to make it have a high heat capacity during use, and then emptied to make it lighter for transportation before and after use. The heavy roller 616 can be aligned with the rear wheel axis or centered on the pivot axis around which the PB vehicle 600 rotates when turning, to minimize sliding of the heavy roller 616. The pivot arm 617 is configured to allow the heavy roller 616 to rise and fall to track variations in the train as the PB vehicle 600 moves across the terrain.

In some implementations, the heavy roller 616 can be divided into two or more independent rollers (see, e.g., FIG. 6A) to minimize sliding when the PB vehicle 600 is making a turn. The independent rollers can be mounted on the same axle with a single pivot arm system. Alternatively, each independent roller can be mounted on its own pivot arm system for better tracking of the terrain. Preferably, the heavy roller system is centered on the same vertical rotation axis for the steering of the PB vehicle 600 to minimize sliding of the heavy roller(s) 616 during turns.

In the embodiment shown in FIG. 6, the PB vehicle 600 includes three arrays (rows) of torches 240. It is understood that the number of torch arrays can vary from one to six or more depending on the size of the PB vehicle 600. The torch arrays can be spaced apart from each other by approximately 10 inches to 24 inches, for example. The torch arrays can be offset from one another in some implementations. Each torch array (row) can include from two to fourteen individual torches spaced apart (e.g., by approximately 4 inches to 8 inches) along the width of the frame 619 (e.g., into the page). In a large PB vehicle 600, for example, the burn chamber 610 can be dimensioned to produce a 5 foot burn strip using three or more arrays of torches 240 (e.g., four, five or six arrays). Two of the torch arrays can have up to thirteen torches 240, and a middle torch array can have up to twelve torches 240. In this configuration, the middle torch array is positionally offset relative to the other two torch arrays. The spacing between individual torches in the width direction can be between four and five inches, for example.

It is noted that, in some PB vehicles, there can be numerous torches 240 with relatively close spacing. Also, there can be different torch densities in the different arrays within the same PB vehicle. For example, with a 5-foot wide burn strip, a first array may have thirteen torches with a spacing of 5 inches between each torch; a second array with twelve torches, also spaced by 5 inches, but offset by 2.5 inches laterally so that the twelve torches cover the gap between the first array of thirteen torches; and finally a third, high-density array of 25 torches with a spacing of 2.5 inches to ensure that burning of the vegetation is very complete before it exits the burn chamber 610.

As shown, an upper portion of the torches 240 extends out of upper enclosure 620 beyond the burn chamber 610. This portion of the torches 240 includes the torch igniter transformers, insulating end cap, and air/gas inlet (see, e.g., FIG. 1), which can be harmed by excessive heat within the burn chamber 610. The remaining portion of the torches 240 are situated within the burn chamber 610.

In some implementations, and with reference to FIG. 6B, the torches 240 are mounted to the frame 619 via a mechanism that allows the height of the torches 240 to be adjusted, either manually or via a stepper or servo motor. The torch adjustment mechanism can be used to position the hottest part of the flame where desired, control the burn rate, spread of the flame, and minimize propane gas consumption.

It is noted that very high burn temperatures can be used to eradicate certain invasive plant species (e.g., Scotch Broom), while lower temperatures may be appropriate to protect soil and other species. A PB vehicle of the present disclosure can be used in land management applications as it can solve problems that exist now with the suppression and eradication of invasive species of plants. There are few ways to effectively remove some invasive species, and burning is one of them, but comes with risks of escaped fire. Using a PB vehicle of the present disclosure to burn invasive species of plants can solve this problem.

Another example of land management that can benefit from a PB vehicle of the present disclosure is agricultural stubble burning to remove plant stalks after harvesting. This is used widely worldwide, and it is one of the best and cheapest way to remove harvest stubble. But, especially in Southeast Asia where it is used extensively, and is usually unregulated, burning agricultural stubble is a significant contributor to poor air quality due to the smoke it produces. A PB vehicle with its smoke treatment system can solve this problem.

FIG. 6B illustrates a torch height adjustment system in accordance with any of the embodiments disclosed herein. The torch height adjustment system 660 allows the height off the ground of each linear array of torches 240 to be continuously adjustable over a limited range. FIG. 6B illustrates a motorized mechanism 661 that allows the height of the torches 240 to be controllably adjusted via a stepper or servo motor 662. Each of the torches 240 of the torch array is connected to a torch yoke 664. Each array of torches 240 is connected to the torch yoke 664 such that the torch igniters 256 are positioned above the torch yoke 664. It is understood that a PB vehicle may include a plurality of torch arrays, and that the torches 240 of each individual torch array is connected to its own torch yoke 664 and motorized mechanism 661. The motorized mechanism 661 includes a pair of stepper or servo motors 662 connected to the frame 619 via a support 666. Each of the stepper or servo motors 662 drives a lead screw 663 which passes through a threaded hole in the torch yoke 664.

The stepper or servo motors 662 are synchronized to adjust the height of each torch array. The stepper or servo motors 662 can be synchronized either electronically or by use of a mechanical linkage. In the case of a mechanical linkage, a single motor 662 may instead be used to drive both lead screws 663.

The two stepper or servo motors 662 allow remote-controlled, dynamic height adjustment during operation of the PB vehicle 600, and can be done automatically via a computer algorithm, or an operator manually. For example, actuation of the stepper or servo motor 662 is controlled by the controller or central computer of the PB vehicle 600. It is also possible for the torch height to be only manually adjustable, such that the lead screws 663 are turned by an operator using either one or two hand cranks.

The turning direction of the lead screw 663 dictates the vertical displacement of the torch yoke 664 and, therefore, the array of torches 240. For example, turning the lead screw 663 in a first direction causes the torch yoke 664 to raise the array of torches 240. Turning the lead screw 663 in a second direction opposite the first direction causes the torch yoke 664 to lower the array of torches 240. The adjustment range can be anywhere between 8 inches and 24 inches, depending on the size of the particular PB vehicle model and the specific design of the machine for its intended use. Torch height adjustment is useful in combination with the adjustability of the flame temperature and flame length to tailor the burn plan to different types of vegetation.

Torch guides 668 can be connected to the frame 619 to help guide and limit the movement of the torches 241 when subject to vertical displacement. The pipes of the torches 240 pass through the torch guides 668 that keep the torches 240 separated, and at their proper angle while allowing them to slide up or down freely during height adjustment.

Operating the torches 240 at a lean air/gas mix keeps the flame temperature low, even at relatively high flow rates, so that the flame can be cooler while projecting downwards forcefully. Operating the torches 240 at a rich air/gas mix also produces a “softer” and cooler flame with less downward projection if that is needed for certain types of vegetation. When operating the torches 240 at an optimal air/gas mix, the flame temperature is maximized, and the torches 240 can operate with this mixture at varying flow rates to adjust flame length. This adjustability of the torches 240 is facilitated by having a blower 521 to supply the air, and having independent control over the blower flow and the propane (or other gas) flow. As previously discussed, the use of the blower 521 to supply the air (oxygen) to the torches 240 is important because the torches 240 are located inside the burn chamber 610, and cannot use smokey, dirty air drawn from the burn chamber 610. As previously discussed, the air/gas mix and flow rate to the torches 240 is controlled by the controller or central computer of the PB vehicle 600.

The PB vehicle 600 includes a filtration apparatus 640 which includes an extractor fan 642, a smoke filtration system 646, and ductwork 644 provided between the extractor fan 642 and the smoke filtration system 646. As shown in FIG. 4, the upper enclosure 620 can include heat shields that block a direct path to the extractor fan 642 for flames and debris. The smoke filtration system 646 is configured to filter smoke and greenhouse gasses from the effluent expelled from the burn chamber 610 by the extractor fan 642. The smoke filtration system 646 can be configured to remove particulates, including smoke, ash and dust, such as by removing harmful smoke in the particle size range of 2.5 to 10 microns (PM 2.5 and PM 10). The smoke filtration system 646 can be configured to remove harmful chemical vapors and greenhouse gasses such as CO, CO₂, methane and other noxious gasses. In FIG. 6, the smoke filtration system 646 is shown as a single system arranged in-line with the longitudinal axis of the frame 619. In some implementations, the smoke filtration system 646 can extend along one side of the frame 619. In other implementations, the smoke filtration system 646 can be split into two duplicative systems, with one system extending over a first side of the frame 619 and a second system extending over a second opposing side of the frame 619.

FIG. 7 illustrates a filtration apparatus 640 in accordance with any of the embodiments disclosed herein. The filtration apparatus 640 includes an extractor fan 642, smoke filtration system 646, and ductwork 644 provided between the extractor fan 642 and the smoke filtration system 646. The smoke filtration system 646 includes a tank 650 for containing a filtering liquid 651. A pump 652 is situated at the bottom of the tank 650 and is configured to pump the filtering liquid 651 upwardly through a vertical tube 654. The filtering liquid 651 can be water or a solution containing chemicals to give it certain desirable properties that aid in the filtering efficacy. The filtering liquid 651 can be chosen specifically to absorb particular gases such as urea which is a solvent for NOx compounds. The viscosity of the filtering liquid 651 can be chosen to maximize capture of particular types of smoke. The tank 650 includes a filtered air outlet 655.

The liquid-based smoke filtration system 646 can be implemented to handle relatively high loads of smoke, ash and noxious gasses compared with typical sieve-type filters. As compared with a sieve-type filter, the liquid-based smoke filtration system 646 can also deal with high temperature gasses and particles, and absorb molecules such as NOx compounds. A HEPA filter 659 or other type of filter can be provided at the outlet 655 as a final, additional filtering stage of the smoke filtering system 646. The HEPA filter 659 will not burn, or get overloaded too quickly, because the air at the outlet 655 of the smoke filtration system 646 will already have been mostly cleaned and cooled via the filtering liquid 651.

The vertical tube 654 includes a series of spray nozzles 656 which produce a horizontal spray of the filtering liquid 651. The spray nozzles 656 are spaced apart from one another in the vertical direction to define discrete spray stages 657. In the representative example shown in FIG. 7, there are four such spray stages 657. It is understood that the number of spray stages 657 will vary, and that the four spray stages 657 shown in FIG. 7 is for purposes of illustration only. Each spray stage 657 can include a number of spray nozzles 656 disposed about the perimeter of the tube 654. The spray nozzles 656 produce a spray pattern that projects substantially horizontally within the ductwork 644. Preferably, the number of spray nozzles 656 is sufficient to produce a cumulative spray pattern covering about 3600 for each spray stage 657.

Disposed at or between each spray stage 657 is filtering material 658, referred to as filtering “wool.” The filtering wool can be, or include, an amorphous, fibrous, highly-porous non-flammable material with a large surface area. The filtering wool can be, or include, plastic filler material which is traditionally used to trap dust and hair in furnaces. Steel wool is a suitable filtering wool. Long, tangled spring material, as well as bundles of steel curls, can be used as filtering wool. The filtering wool 658 helps increase the time and area over which the dirty air interacts with the filtering liquid 651, thereby increasing the efficacy of the filtering. The filtering wool 658 can also have catalytic properties to help trap specific noxious molecules.

As is shown in FIG. 7, smoke-filled air from the burn chamber 610 is forced up and out through the ductwork 644 then downward into the smoke filtration system 646 via the extractor fan 642. The extractor fan 642 can be located directly on top of the burn chamber 610. In some implementations, the extractor fan 642 can be positioned further away from the burn chamber 610 in the ductwork 644 (e.g., see extractor fan position 642a). As previously mentioned, the filtering apparatus 640 can include more than one extractor fan 642. The extractor fan 642 pulls smoke-filled air from the burn chamber 610 and forces it through the ductwork 644 and to the smoke filtration system 646. Coaxial to the downward section of the ductwork 644a is the vertical tube 654, which is plugged at the top. The bottom of the vertical tube 654 is attached to the pump 652 positioned in the tank 650.

The pump 652 forces the filtering liquid 651 up and out of the horizontal spray nozzles 656 and against the sides of the ductwork 644a where it drips down the sides of the ductwork 644a. The spray also saturates the filtering wool 658. As the dirty air is forced downward through the ductwork 644a, it passes through the sprays produced by the spray nozzles 656. The smoke and noxious gases are trapped by droplets in the sprays produced by the spray nozzles 656, and are carried down with the droplets into the filtering liquid 651 contained within the tank 650. The filtering liquid 651 is recycled via the pump 652 into the tank 650, and will accept a high concentration of smoke, ash and chemicals 653 before it must be replaced. A course filter can be provided on the inlet of the pump 652 to prevent very large particles, hairs, and other debris from clogging the pump 652. In some cases, depending on the chemical composition of the filtering liquid 651, it may be practical, and even beneficial, to dump the dirty liquid 651 into the soil as it may contain good nutrients.

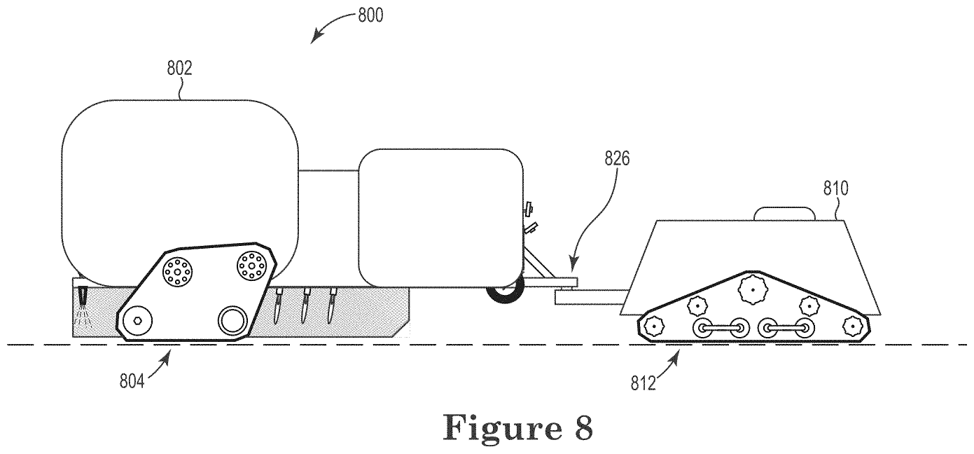

FIG. 8 illustrates a PB vehicle in accordance with any of the embodiments disclosed herein. The PB vehicle 800 shown in FIG. 8 can be implemented as a towed vehicle according to the embodiments shown in FIGS. 1, 3, 4 and 6. The PB vehicle 800 is provided with a full, weatherproof enclosure 802. In this representative embodiment, the PB vehicle 800 includes a rear track system 804 rather than a rear wheel system. Because the PB vehicle 800 is designed to be towed by a tow vehicle 810, the track system 804 can be passive (non-motorized). As shown, the tow vehicle 810 has an active (motorized) track system 812, and is connected to the PB vehicle 800 by a hitch (e.g., a ball-type hitch). The tow vehicle 810 can be a remote-controlled vehicle or an autonomous vehicle. Alternatively, the tow vehicle can be a bulldozer or a tractor.

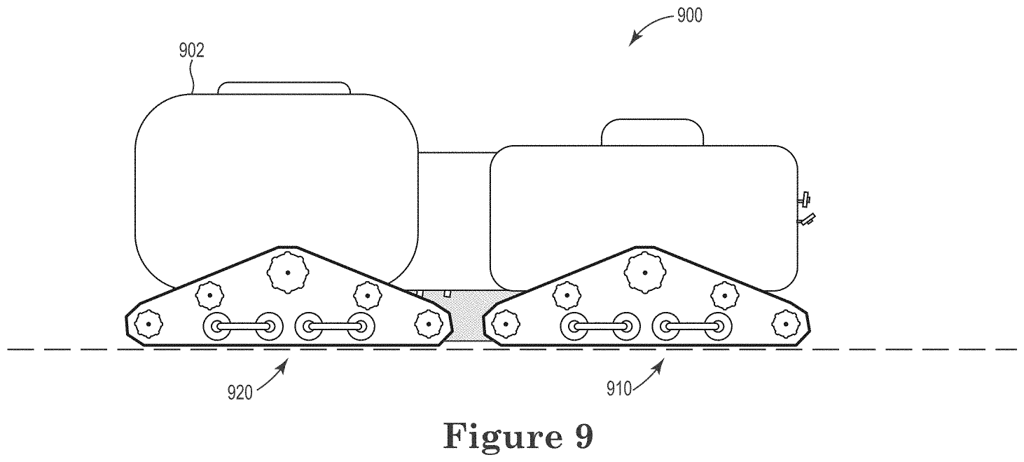

FIG. 9 illustrates a PB vehicle in accordance with any of the embodiments disclosed herein. The PB vehicle 900 shown in FIG. 9 can be implemented as a self-propelled vehicle according to the embodiment shown in FIG. 2, and can include the systems and components shown in FIGS. 3, 4 and 6. The PB vehicle 900 can be a remote-controlled vehicle or a fully autonomous vehicle. The PB vehicle 900 is provided with a full, weatherproof enclosure 902. In this representative embodiment of the PB vehicle 900, one or both of a front track system 910 and a rear track system 920 can be an active track system. It is understood that the PB vehicle 900 or other PB vehicles disclosed herein can utilize wheels, tracks systems, or a combination of wheels and track systems. For example, the front section may include a drive train with tracks, while the rear section has wheels. Selection between tracks and wheels depends on the specific terrain over which the PB vehicle 900 is designed to traverse.

As was previously discussed, different sizes of PB vehicles can be provided for use in different circumstances. Smaller PB vehicles can be used in tight areas, while larger PB vehicles can be used to cover large areas quickly. The different sizes of PB vehicles may have different types of drive systems (e.g., towed or self-propelled), and different rolling systems (e.g., tracks, wheels, or a combination). A special suspension system may be used to help the PB vehicle cover rough, uneven, or slope terrain. The suspension system may be passive or active. If active, the suspension system can be configured to automatically adjust to the terrain as needed based on sensors that monitor terrain, engine torque, and other parameters. It is noted that the special suspension system may be used with tracks or wheels to aid in negotiating difficult terrain.

For PB vehicles that include tracks or wheels, the steering system preferably allows the PB vehicle to rotate freely about an axis that is perpendicular to the ground so it can turn tightly, as needed. The steering system can be passive or active. As a towed vehicle, the steering system of the PB vehicle is typically passive. A passive steering system refers to a system in which the wheels or tracks are either independent or have a differential that allows the PB vehicle to turn as tightly as needed to follow the towing vehicle. The towing hitch is configured to allow the PB vehicle to turn, and also pitch and roll to some degree, to accommodate variations in the terrain. A common ball-type hitch or a variation of same can be used. The body of the PB vehicle may have an articulated joint so that it can twist and flex to some degree to facilitate turns, and accommodate bumps, dips, and other variations in the terrain.

FIG. 10 illustrates a method of performing a prescribed burn of vegetative ground fuel in accordance with any of the embodiments disclosed herein. The method involves transporting 1000 a burn chamber of a PB vehicle over ground that contains vegetative ground fuel. The method also involves igniting 1002 vegetative ground fuel within a prescribed burn region of the ground using an ignition source (e.g., an array of torches) disposed in the burn chamber. The method further involves confining 1004 burning of the vegetative ground fuel to the prescribed burn region, and expelling 1006 residual effluent from the burn chamber. The method can also involve filtering 1008 smoke and greenhouse gasses from the expelled residual effluent. The method can further include extinguishing 1010 residual flames and embers. The method shown in FIG. 10 can be performed continuously while moving the burn chamber over the ground. Alternatively, the method can be performed in a step-wise fashion (e.g., in a start/stop manner) as previously discussed.

The speed at which a prescribed burn of vegetative ground fuel can be performed by a PB vehicle is based on a number of factors including, for example, the number and arrangement of ignition sources (e.g., array of torches), the length and temperature of flames produced by the ignition source or sources, the overall size and length of the burn chamber, and the spacing between the source of the flames (e.g., the terminal end of the torches) and the ground, among other factors. It was found through experimentation with a prototype PB vehicle that an array of four torches in a horizontal line oriented perpendicular to the direction of travel produced a prescribed burn of approximately 2 feet wide. It can be appreciated that the size of the prescribed burn region of the ground can be scaled upward or downward by the number and arrangement of torches or other ignition sources disposed in the burn chamber of the PB vehicle. In some implementations, a PB vehicle can be implemented to perform a prescribed burn at a rate of about 0.5 to about 1 acre/hour. In terms of meters per second, a PB vehicle can be implemented to perform a prescribed burn by traveling at a rate of about 0.5 to about 1 m²/second.

As previously discussed, the PB vehicle includes one or more controllers that communicate with various components (e.g., fuel supply system, air supply system, water supply system, sensors, actuators) over a communication network (e.g., a CAN bus). The controller(s) of the PB vehicle can be programmed with different setup routines that configure the components of the PB vehicle for specific use scenarios. The PB vehicle components can be configured differently for operation in different conditions and for different vegetation. For example, PB vehicle components can be configured for operation in tall grass/brush conditions, short grass/brush conditions, conditions involving leaves and/or needles, different agricultural conditions (e.g., different crops), different grades (e.g., level or hilly/steep grades), different moisture levels in the vegetation, and different local wind/environment conditions (e.g., low vs. high humidity, low vs. high wind, low vs. high ambient temperatures). Each specific operating scenario can have unique operating parameters that dictate the length and temperature of the flames, the speed of the mulchers/cutters, rate of travel of the PB vehicle, and flow rate of the extinguisher, among other parameters.

### Example

Physical dimensions: L 5′-15′, W 3′-8′, H 3′-6′

Two models for BurnBot™:
BurnBot™ Mini is 5′×3′×3′,
BurnBot™ Standard is 15′×8′×6′.
   Other models may range within these dimensions. Different models will fit different applications/terrains.

### Propulsion System:

In this example, the BurnBot™ is designed as a towed vehicle. This provides the most flexibility in the propulsion system. It can be towed by an ATV, tractor, mower or any other vehicle suitable for the terrain. It can also be towed by a winch, which allows it to be used on very steep hills, if necessary. The towing vehicle can be manually or remotely driven, or autonomous. This design offers the most flexibility.

### Pre-Processing of Vegetation to be Burned:

The front of the BurnBot™ can incorporate mowers, mulchers, bulldozers as needed for the terrain. As a towed vehicle, the BurnBot™ can utilize any of these machines as towing vehicles. In addition, the BurnBot™ can include image and non-image based fuel analysis to set burn parameters dynamically.

Burn stripe width: 2′ (with Burnbot™ Mini) and 6.5′ (with Burnbot™ Standard)

Max. planned travel speed while burning: ˜1.0 m/sec. (˜2.24 mph.)

Min. planned travel speed while burning: ˜0.2 m/sec. (˜0.45 mph.)

Target travel speed while burning: 0.5 m/sec. (1.12 mph.)

### Target Burn Rate in the Field (Full Vegetation Fuel Consumption): ˜1 Acre/Hour

This is assuming a burn strip width of ˜2 m and a travel speed of ˜0.6 m/sec. Note that burn rates can be higher assuming less than complete consumption of vegetation fuel.

LP gas torch flame temperature: 5000-3600° F. (adjustable by control of the LP gas/air mixture)

### LP Gas (Propane) Consumption: 2-10 CFM, Depending on Several Parameters Including:

Number of torches operating (torch spacing and number of rows are variable).
Torch flame length (more gas required for longer flames).
Torch flame temperature (gas/air mix is used to control flame temperature).
All above parameters can be dynamically tailored to fuel type, density, moisture and travel speed.

Alternatives to LP gas such as Bio LP gas, methane (preferably collected from farm waste, and other natural sources), hydrogen (ideally collected from gasification of biomass which is currently being developed), and vaporized alcohols may be used.

### Burn Chamber Internal Temperature Max.: 1200° F.

### Power Supply: 9.5-150 kW Generator (Depending on Size of the BurnBot™ Model)

This generator can be powered by gasoline, diesel, propane, or a bio fuel. The generator powers all machinery and electronics on the BurnBot™

### Flame, Ember, and Spark Containment:

This is accomplished using several devices and methods in concert including:
Solid metal front and rear doors (hinged to allow material in and out during travel)
Solid metal sides down to the ground clearance level.
Non-flammable cloth and/or chain mail skirts on sides down to ground level for flexible, air-permeable shielding.
A powerful extractor fan that draws air in along the bottom edges of the burn chamber.
Inward airflow around bottom perimeter aids in containment of flames and material.
Water and/or LN2 extinguishers along the sides and at rear.

### Smoke and Noxious Fume Mitigation:

Both particulate smoke (PM2.5 and PM10), and other noxious fumes are minimized by several mechanisms. These work together in series, and can have multiple stages of the same filter type in series to increase filtering efficacy, if needed. These include:
High temperature, high-airflow burn using clean burning propane (produces much less smoke).
The full volume of air and smoke in the burn chamber is extracted approximately once per second via a fan.
The extracted air is contained, and sent to the multi-stage smoke filtering system.
The main stage is liquid based, forcing the air to interact with a liquid, trapping fumes in the liquid.
This may be enhanced using a centrifugal approach via a spinning, long-axis cylindrical wheel.
This may also be enhanced using convoluted catalytic material, such as metallic wool.
Multiple liquid filtering stages may be used.
Subsequent filtering stages may be used containing various catalytic converters.
Additional stages may include HEPA-type filters, and electrostatic filtering, if needed.

### Flame, Ember and Hot-Spot Extinguishing:

Several methods are applied in series at the rear of the BurnBot™ to ensure that no left-over flames, hot embers, or hot spots exist after the BurnBot™ has passed. These include:
Thermal imaging/image processing to check for any hot spot that can cause ignition.
Water sprinklers with multiple jets that can be selectively turned on over the hot spot.
In addition, LN2 sprayers may also be used at the rear sides, and rear for extinguishment.
Finally, a heavy, high-heat-capacity roller(s) crush, smother, and cool any hot vegetation.

Although reference is made herein to the accompanying set of drawings that form part of this disclosure, one of at least ordinary skill in the art will appreciate that various adaptations and modifications of the embodiments described herein are within, or do not depart from, the scope of this disclosure. For example, aspects of the embodiments described herein may be combined in a variety of ways with each other. Therefore, it is to be understood that, within the scope of the appended claims, the claimed invention may be practiced other than as explicitly described herein.

All references and publications cited herein are expressly incorporated herein by reference in their entirety into this disclosure, except to the extent they may directly contradict this disclosure. Unless otherwise indicated, all numbers expressing feature sizes, amounts, and physical properties used in the specification and claims may be understood as being modified either by the term “exactly” or “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein or, for example, within typical ranges of experimental error.

The recitation of numerical ranges by endpoints includes all numbers subsumed within that range (e.g. 1 to 5 includes 1, 1.5, 2, 2.75, 3, 3.80, 4, and 5) and any range within that range. Herein, the terms “up to” or “no greater than” a number (e.g., up to 50) includes the number (e.g., 50), and the term “no less than” a number (e.g., no less than 5) includes the number (e.g., 5).

The terms “coupled” or “connected” refer to elements being attached to each other either directly (in direct contact with each other) or indirectly (having one or more elements between and attaching the two elements). Either term may be modified by “operatively” and “operably,” which may be used interchangeably, to describe that the coupling or connection is configured to allow the components to interact to carry out at least some functionality (for example, a radio chip may be operably coupled to an antenna element to provide a radio frequency electric signal for wireless communication).

Terms related to orientation, such as “top,” “bottom,” “side,” and “end,” are used to describe relative positions of components and are not meant to limit the orientation of the embodiments contemplated. For example, an embodiment described as having a “top” and “bottom” also encompasses embodiments thereof rotated in various directions unless the content clearly dictates otherwise.

Reference to “one embodiment,” “an embodiment,” “certain embodiments,” or “some embodiments,” etc., means that a particular feature, configuration, composition, or characteristic described in connection with the embodiment is included in at least one embodiment of the disclosure. Thus, the appearances of such phrases in various places throughout are not necessarily referring to the same embodiment of the disclosure. Furthermore, the particular features, configurations, compositions, or characteristics may be combined in any suitable manner in one or more embodiments.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the disclosure.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

As used herein, “have,” “having,” “include,” “including,” “comprise,” “comprising” or the like are used in their open-ended sense, and generally mean “including, but not limited to.” It will be understood that “consisting essentially of,” “consisting of,” and the like are subsumed in “comprising,” and the like. The term “and/or” means one or all of the listed elements or a combination of at least two of the listed elements.

The phrases “at least one of,” “comprises at least one of,” and “one or more of” followed by a list refers to any one of the items in the list and any combination of two or more items in the list.

What is claimed is:

1. An apparatus configured to perform a prescribed burn of vegetative ground fuel, comprising:
a movable platform configured to traverse ground that contains the vegetative ground fuel;
a burn chamber disposed on the movable platform;
a plurality of torches disposed in the burn chamber and configured to ignite vegetative ground fuel within a prescribed burn region of the ground;
an air supply system and a fuel supply system fluidically coupled to the plurality of torches;
a containment arrangement situated relative to the burn chamber and configured to confine burning of the vegetative ground fuel to the prescribed burn region; and
a discharge apparatus positioned relative to the burn chamber and configured to expel residual effluent from the burn chamber.

2. The apparatus of claim 1, wherein the plurality of torches are directed towards the ground.

3. The apparatus of claim 1, wherein:
the plurality of torches comprises a first set of torches and a set of second torches;
the first set of torches are directed towards the ground; and
the second set of the torches are directed away from the ground and configured to burn smoke captured within the burn chamber.

4. The apparatus of claim 1, wherein each of the torches produces a flame having a length of about 1 foot to about 3 feet.

5. The apparatus of claim 1, wherein each of the torches produces a flame having a temperature of about 500° F. to about 3600° F.

6. The apparatus of claim 1, wherein:
each of the torches is operatively coupled to an igniter;
each igniter comprises a high voltage source coupled to an electrical conductor extending axially along a respective torch;
the electrical conductor comprises or is coupled to a hook at a terminal end of the electrical conductor; and
the high voltage source is configured to generate an electrical arc at the hook for igniting a fuel transported through a respective torch.

7. The apparatus of claim 1, wherein the air supply system comprises a blower fluidically coupled to each of the torches and configured to supply air for supporting a flame generated by each torch.

8. The apparatus of claim 1, wherein the fuel supply system is configured to supply propane fuel.

9. The apparatus of claim 1, wherein the containment arrangement comprises:
a front panel extending from the burn chamber and comprising a front hinged section configured to facilitate entry of vegetative ground fuel into the burn chamber;
a rear panel extending from the burn chamber and comprising a rear hinged section configured to facilitate exit of burnt vegetative ground fuel out of the burn chamber; and
opposing side panels extending from the burn chamber and comprising a lower non-flammable skirt configured to allow air to enter the burn chamber and inhibit embers, flames, and debris from exiting the burn chamber.

10. The apparatus of claim 1, wherein the discharge apparatus comprises an extractor fan fluidically coupled to the burn chamber, the extractor fan situated externally of the burn chamber and configured to expel the residual effluent from the burn chamber.

11. The apparatus of claim 1, comprising a smoke filtration system configured to filter the residual effluent.

12. The apparatus of claim 11, wherein the smoke filtration system comprises:
a tank containing a filtering liquid;
a sprinkler system disposed within ductwork of the smoke filtration system;
a pump disposed in the tank and configured to pump the filtering liquid through the sprinkler system; and
an outlet for expelling filtered air.

13. The apparatus of claim 12, wherein the sprinkler system comprises:
a plurality of discrete spray stages each comprising one or more spray nozzles; and
non-flammable filtering material disposed at or between each of the discrete spray stages.

14. The apparatus of claim 1, comprising an extinguisher disposed within or proximate an exit of the burn chamber.

15. The apparatus of claim 1, comprising one or both of a heavy roller and a mulcher disposed within or proximate an exit of the burn chamber.

16. The apparatus of claim 1, wherein:
the movable platform comprises a first platform situated ahead of a second platform relative to a direction of travel;
the second platform is configured to support the burn chamber, the torches, the containment arrangement, and the discharge apparatus; and
the first platform is configured to support a generator for the apparatus, the fuel supply system, the air supply system, and a computer-based control system configured to control operation of the apparatus.

17. An apparatus configured to perform a prescribed burn of vegetative ground fuel, comprising:
a movable platform configured to traverse ground that contains the vegetative ground fuel;
a hitch configured to couple the movable platform to a tow vehicle or a secondary movable platform;
a burn chamber disposed on the movable platform;
a plurality of torches disposed in the burn chamber and configured to ignite vegetative ground fuel within a prescribed burn region of the ground;
an air supply system and a fuel supply system fluidically coupled to the plurality of torches;
a containment arrangement situated relative to the burn chamber and configured to confine burning of the vegetative ground fuel to the prescribed burn region;
a discharge apparatus positioned relative to the burn chamber and configured to expel residual effluent from the burn chamber; and
a smoke filtration system configured to filter the residual effluent.

18. The apparatus according to claim 17, wherein the smoke filtration system comprises:
a tank containing a filtering liquid;
a sprinkler system disposed within ductwork of the smoke filtration system;
a pump disposed in the tank and configured to pump the filtering liquid through the sprinkler system; and
an outlet for expelling filtered air.

19. A method of performing a prescribed burn of vegetative ground fuel, comprising:
moving a burn chamber of a prescribed burn vehicle over ground that contains the vegetative ground fuel;
igniting vegetative ground fuel within a prescribed burn region of the ground using torches disposed in the burn chamber;
confining burning of the vegetative ground fuel to the prescribed burn region; and
expelling residual effluent from the burn chamber.

20. The method of claim 19, comprising filtering smoke from the expelled residual effluent.

21. The method of claim 19, comprising adjusting one or more of a flame length and a flame temperature by adjusting one or both of a fuel supply system and an air supply system of the prescribed burn vehicle.

22. The method of claim 19, wherein the prescribed burn of the vegetative ground fuel is performed continuously while moving the burn chamber over the ground.
